(19) United States
(12) Patent Application Publication
(10) Pub. No.: US 2024/0064202 A1
(43) Pub. Date: Feb. 22, 2024

(54) METHODS AND APPARATUS TO SYNCHRONIZE TOUCH EVENTS

(71) Applicant: Intel Corporation, Santa Clara, CA (US)

(72) Inventors: Kishore Kasichainula, Phoenix, AZ (US); Aswin Padmanabhan, Gilbert, AZ (US); Satyeshwar Singh, Folsom, CA (US); Karthik Tyamgondlu, Chandler, AZ (US); Marcos Paulo Da Silva, Chandler, AZ (US)

(21) Appl. No.: 18/497,839

(22) Filed: Oct. 30, 2023

(51) Int. Cl. H04L 67/1095; G06F 15/173; H04L 12/46

(52) U.S. Cl. CPC H04L 67/1095; G06F 15/17331; H04L 12/4645

(57) ABSTRACT

Systems, apparatus, articles of manufacture, and methods are disclosed. An example apparatus to synchronize event data includes first circuitry to implement a user interface controller. The user interface controller of the example apparatus is to detect a user input, transmit a message including event data to a network interface controller (NIC), the event data corresponding to the user input, and provide the event data to a driver to cause an event corresponding to the event data to be rendered by the apparatus. The example apparatus also includes second circuitry to implement the NIC. The NIC of the example apparatus is to store the event data from the message in a local buffer of the NIC, obtain the event data from the local buffer using a direct memory access (DMA) request, and transmit a packet including the event data over a network.

### FIELD OF THE DISCLOSURE

This disclosure relates generally to touchscreen devices and, more particularly, to methods and apparatus to synchronize touch events.

### BACKGROUND

Touchscreen devices enable users to perform a wide variety of functions, such as scrolling, panning, zooming, handwriting, coloring, highlighting, annotating, etc. Accordingly, the use of touchscreen devices have increased in recent years as a manner of communicating within a collaborative environment. For example, in some applications, a presenter annotates on a touchscreen device and the annotations are displayed on other devices used by audience members. The foregoing use-case and similar use-cases may be employed in industries including but not limited to education, retail, and business. As such,

### BRIEF DESCRIPTION OF THE DRAWINGS

FIG. 1 is an illustrative example of touch devices with synchronized touch events.

FIG. 2 is a block diagram of an example implementation of two of the touch devices of FIG. 1.

FIG. 3 is a block diagram of example system on a chip (SoC) circuitry included in the touch devices of FIG. 2.

FIG. 4 is a block diagram of an example Vendor Defined Message (VDM) message utilized by the touch devices of FIG. 2.

FIG. 5 is a flowchart representative of example machine readable instructions and/or example operations that may be executed, instantiated, and/or performed by example programmable circuitry to implement one or more of the touch devices of FIG. 2.

FIG. 6 is a flowchart representative of example machine readable instructions and/or example operations that may be executed, instantiated, and/or performed by example programmable circuitry to forward a touch request, packetize the touch request, and send the packet over the network as described in FIG. 5.

FIG. 7 is a flowchart representative of example machine readable instructions and/or example operations that may be executed, instantiated, and/or performed by example programmable circuitry to implement one or more of the touch devices of FIG. 2.

FIG. 8 is a flowchart representative of example machine readable instructions and/or example operations that may be executed, instantiated, and/or performed by example programmable circuitry to de-packetize the touch event and transfer the touch event to the touch controller as described in FIG. 7.

FIG. 9 is a block diagram of an example processing platform including programmable circuitry structured to execute, instantiate, and/or perform the example machine readable instructions and/or perform the example operations of FIGS. 5-8 to implement the touch device 102A of FIGS. 2 and 3.

FIG. 10 is a block diagram of an example implementation of the programmable circuitry of FIG. 9.

FIG. 11 is a block diagram of another example implementation of the programmable circuitry of FIG. 9.

FIG. 12 is a block diagram of an example software/firmware/instructions distribution platform (e.g., one or more servers) to distribute software, instructions, and/or firmware (e.g., corresponding to the example machine readable instructions of FIGS. 5-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Collaborative communication applications call for accurate touch synchronization in both the touch device that generates touch events and the devices that rely on low latency transfer of said touch events across a network. However, providing accurate and low latency synchronization of touch events is a challenging task. As used above and herein, a touch event refers to data generated when a user makes contact with a touch sensitive device, also referred to herein as a touch device. A touch event may refer to any type of contact, including but not limited to a single finger press, a multi-finger press, an input from a stylus, etc. In some examples, a touch event is interpreted by a touch screen application to determine an action (e.g., scroll, pan, zoom, select, etc.)

Some approaches to synchronize touch events among devices rely on the traversal of touch events across multiple layers of a network protocol stack. For example, touch events are generated by hardware sensors and sent to an operating system kernel module that processes the touch events in chronological order. The kernel module may forward the touch events to a system memory where the events are accessible by a user-space application. The user-space application then copies the touch events into a network user space application. The touch events are forwarded from the network user space application to a network driver space application, where a network controller selects and transmits the touch events across a physical medium (e.g., a network).

When the touch events reach the receiving device, the foregoing operations occur in reverse. That is, to interpret the touch event, the receiving touch device forwards touch events from the network controller up to the user space application and back down to the touch monitor. The traversal of touch events across multiple layers of a network protocol stack in both devices may result in several milliseconds of latency, thereby decreasing the accuracy of the touch synchronization and the quality of the user experience. Furthermore, the exchange of touch event data across a wide number of modules can increase the likelihood of errors. Such errors include but are not limited to applications crashing, hanging, and/or failing to synchronize touch events. Accordingly, such approaches to touch synchronization suffer from performance and reliability issues caused by the traversal of touch events across multiple layers of a network protocol stack.

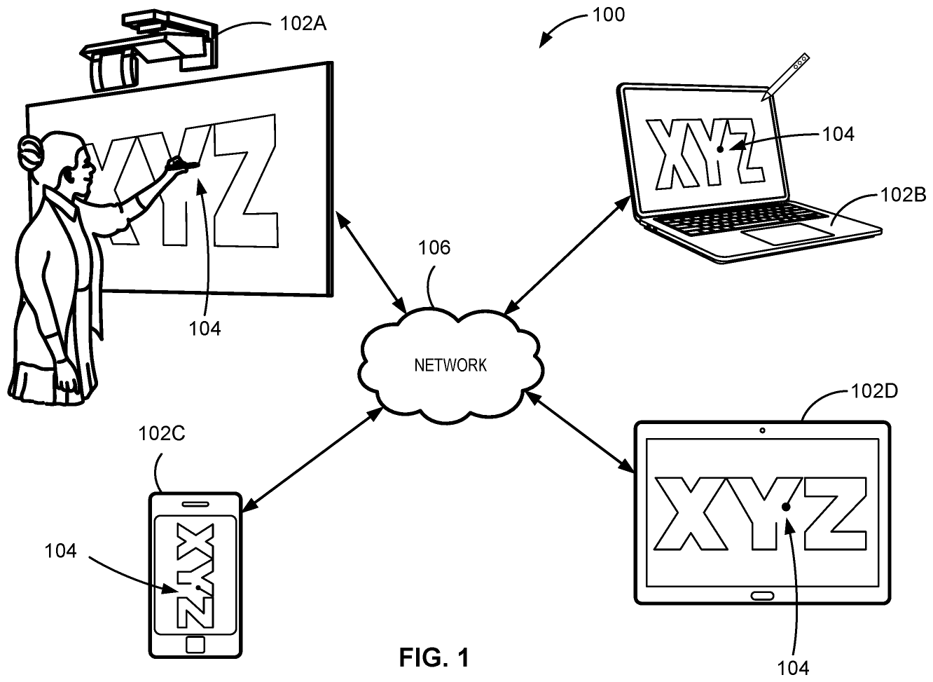

FIG. 1 is an illustrative example of touch devices with synchronized touch events. The example environment 100 includes example touch devices 102A, 102B, 102C, and 102D (collectively referred to as touch devices 102), an example input 104, and an example network 106.

The environment 100 refers to any application in which touch events are synchronized amongst multiple touch devices. In some examples, one or more of the touch devices 102 are in the same geographic location (e.g., a class rooms, lecture halls, conference rooms, etc.). In some examples, one or more of the touch devices 102 within the environment are in different locations (e.g., a user attends a meeting remotely by using a video conferencing software with the touch device 102B).

The touch devices 102 refer to electronic devices that accept touch inputs and can transmit and receive touch events in accordance with the teachings of this disclosure. The touch device 102 may be implemented by any electronic device that can generate and display touch events based on touch inputs. For example, in FIG. 1, the touch device 102A is a smart projector system, the touch device 102B is a laptop, the touch device 102C is a smart phone, and the touch device 102D is a tablet. In some examples, the environment 100 includes different types of touch devices. The touch devices 102B, 102C, and 102D generate touch events based on user inputs to a touch screen. For example, the touch device 102A generates touch events by detecting the position of a stylus in three-dimensional space relative to a displayed image. The example of FIG. 1 shows four touch devices 102. In other examples, the environment 100 may contain any number of touch devices 102. Furthermore, in some examples, the environment 100 includes one or more non-touch devices (e.g., one or more devices that do not accept touch inputs and/or that have touch input capability disabled) but include functionality as disclosed herein to receive and process touch events from one or more of the touch devices 102 in accordance with the teachings of this disclosure.

In the example of FIG. 1, a user makes the input 104 with a stylus connected to the touch device 102A. The touch device 102A generates a touch event based on the input 104 and updates the display using the touch event. The touch device 102A also transmits the touch event to the touch device 102B, 102C, and 102D via the network. In turn, the touch devices 102B, 102C, and 102D use the touch event to update their respective displays and mimic the input 104. For example, the input 104 of FIG. 1 is an annotation that draws part of the letter ‘Y’. To mimic the touch device 102A, the touch devices 102B, 102C, and 102D receive a touch event from the touch device 102A and updates the respective displays to also draw part of the letter ‘Y’. More generally, a first device mimicking a second device may refer to the first device updating a connected display to match, imitate, duplicate, etc., visuals presented on a display of the second device.

In some examples, any number of touch devices 102 may generate touch events from respective user inputs. Similarly, in some examples, any number of touch devices 102 may mimic the input 104 based on a touch event received from a difference device. In some examples, a touch device 102A updates a display to mimic both a first user input performed on a first touch device (e.g., touch device 102B) and a second user input performed on a second touch device (e.g., touch device 102C).

The network 106 of FIG. 1 connects and facilitates communication between the touch devices 102. In this example, the network 106 is the Internet. However, the example network 106 may be implemented using any suitable wired and/or wireless network(s) including, for example, one or more data buses, one or more local area networks (LANs), one or more wireless LANs (WLANs), one or more cellular networks, one or more coaxial cable networks, one or more satellite networks, one or more private networks, one or more public networks, etc. As used above and herein, the term “communicate,” including variances (e.g., secure or non-secure communications, compressed or non-compressed communications, etc.) thereof, encompasses direct communication and/or indirect communication through one or more intermediary components and does not require direct physical (e.g., wired) communication and/or constant communication, but rather includes selective communication at periodic or aperiodic intervals, as well as one-time events.

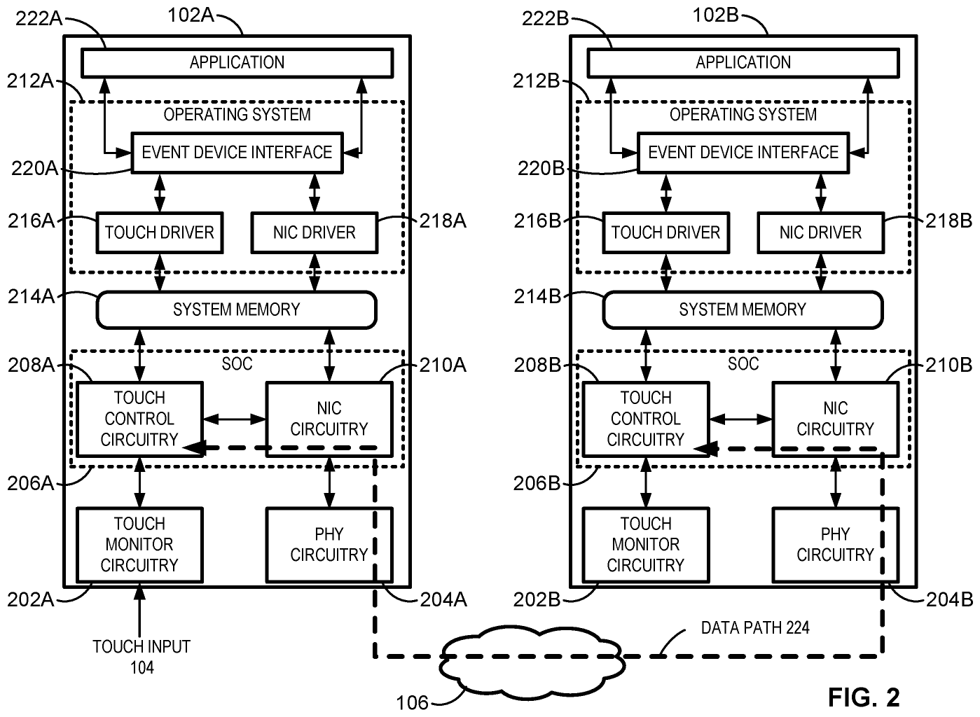

FIG. 2 is a block diagram of an example implementation of the touch devices 102A and 102B of FIG. 1 to synchronize touch events. The touch devices 102A and 102B of FIG. 2 may be instantiated (e.g., creating an instance of, bring into being for any length of time, materialize, implement, etc.) by programmable circuitry such as a Central Processor Unit (CPU) executing first instructions. Additionally or alternatively, the touch devices 102A and 102B of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example of FIG. 2 includes the touch devices 102A and 102B. The touch device 102A includes example touch monitor circuitry 202A, example physical layer (PHY) circuitry 204A, an example SoC 206A, an example operating system (OS) 212A, example system memory 214A, and an example application 222A. The SoC 206A includes example touch control circuitry 208A and example network interface controller (NIC) circuitry 210A. The OS 212A includes an example touch driver 216A, an example NIC driver 218A, and an example event device interface 220A. Similarly, the touch device 102B includes example touch monitor circuitry 202B, example PHY circuitry 204B, an example SoC 206B, an example OS 212B, and an example application 222B. The SoC 206B includes example touch control circuitry 208B and example NIC circuitry 210B. The OS 212B includes example system memory 214B, an example touch driver 216B, example NIC driver 218B, and an example event device interface 220B.

The example touch monitor circuitry 202A of FIG. 2 receives the input 104. Similarly, the touch monitor circuitry 202B may receive touch inputs generated on the touch device 10B. The example touch monitor circuitry 202A and 202B may include a capacitive touch sensors, resistive touch sensors, optical touch sensors, or any other type of touch sensor circuitry. In some examples, the touch monitor circuitry 202A and 202B implement touch panels. The example touch monitor circuitry 202A and 202B may receive touch input from a finger, a palm, a stylus, a glove, etc. In response to receiving the input 104, the example touch monitor circuitry 202A generate a touch event representative of the input 104.

The example PHY circuitry 204A of FIG. 2 implements the physical layer of a network protocol stack by connecting the SoC 206A to the network 106 through a communication interface (e.g., a port, an antenna, etc.). Similarly, the example PHY circuitry 204B implements the physical layer of a network protocol stack by connecting the SoC 206B to the network 106 through a communication interface. The PHY circuitry 204A and 204B of this example may be implemented any number of electronic components (e.g., resistors, capacitors, etc.), optical components, etc., to enable the transmission and reception of data. Additionally, the PHY circuitry 204A and 204B may implement any number of wired and/or wireless communication protocols (e.g., Ethernet®, WiFi®, Bluetooth®, Near Field Communication (NFC), fifth generation cellular networks (5G), sixth generation cellular networks (6G), etc.) to enable a connection to the network 4.

The example SoCs 206A and 206B synchronize touch events in accordance with teachings of this disclosure. Within the SoC 206A, the touch control circuitry 208A stores touch event data in a local memory. Similarly, within the SoC 206B, the touch control circuitry 208B stores touch event data in a local memory. The touch control circuitry 208A and 208B provide the touch event data to other components in the touch devices 102A and 102B, respectively. For example, when a touch event occurs, the touch control circuitry 208A may generate an interrupt to notify a CPU of the relevant information about the touch (e.g., the X and Y coordinates, whether the touch was a touch-down, touch-move, or touch-up event, etc.).

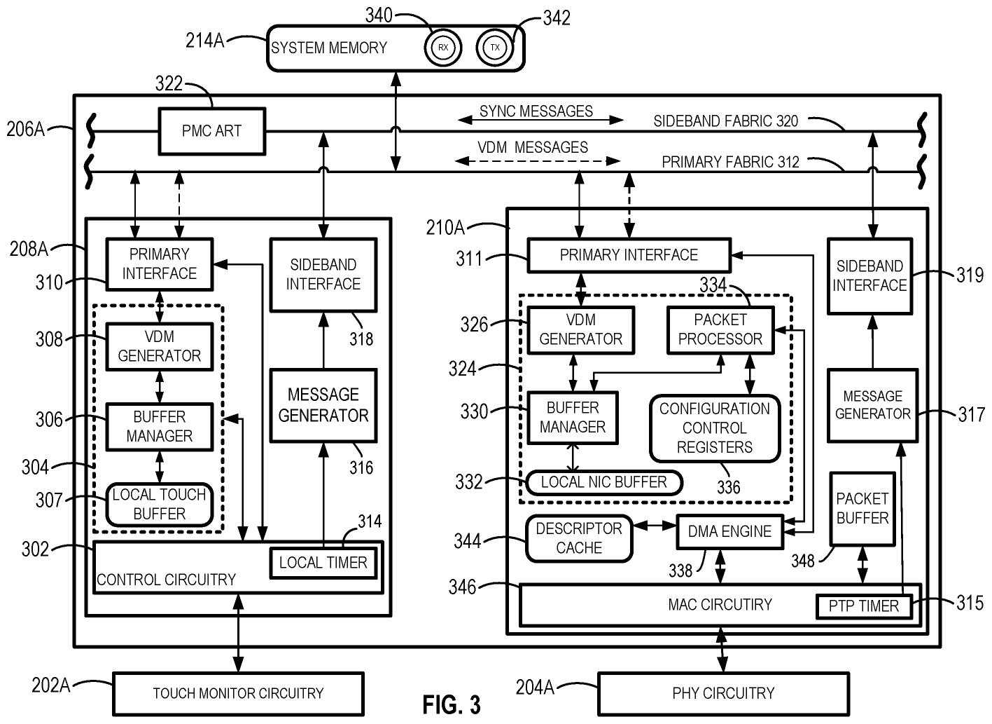

In the example of FIGS. 1 and 2, the touch controller circuitry 208A provides the touch event generated by the touch monitor circuitry 202A directly to the NIC circuitry 210A. To provide the touch data, the touch control circuitry 208A determines how many touch events to package together into a packet, how to format the packet, where to send the packet, and when to send the packet. In some examples, the touch controller circuitry 208A also receives external touch event data from the NIC circuitry 210A. The touch control circuitry 208A is discussed further in connection with FIG. 3.

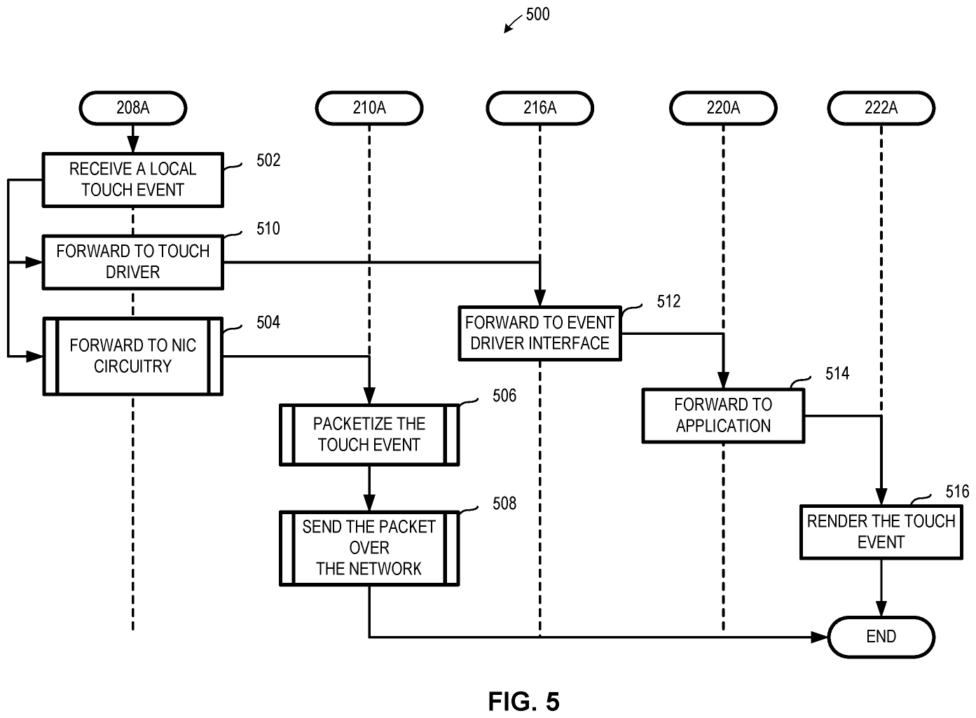

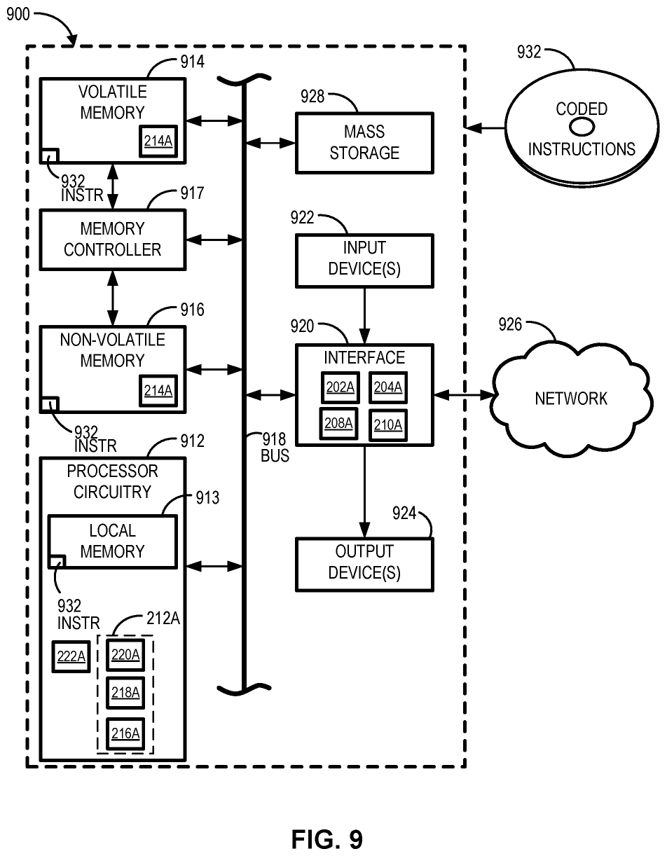

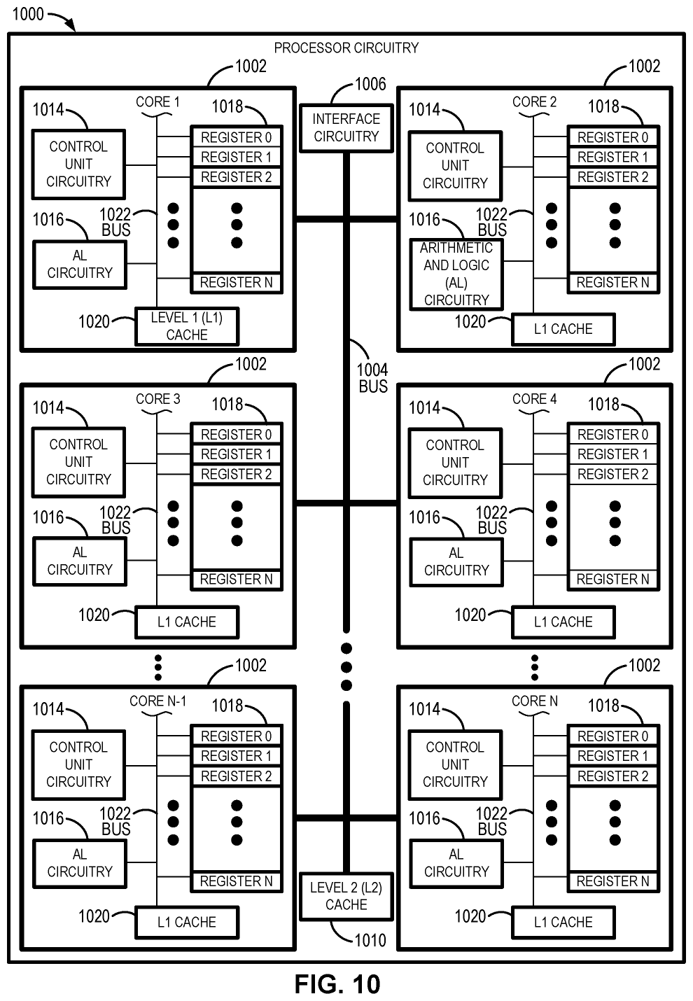

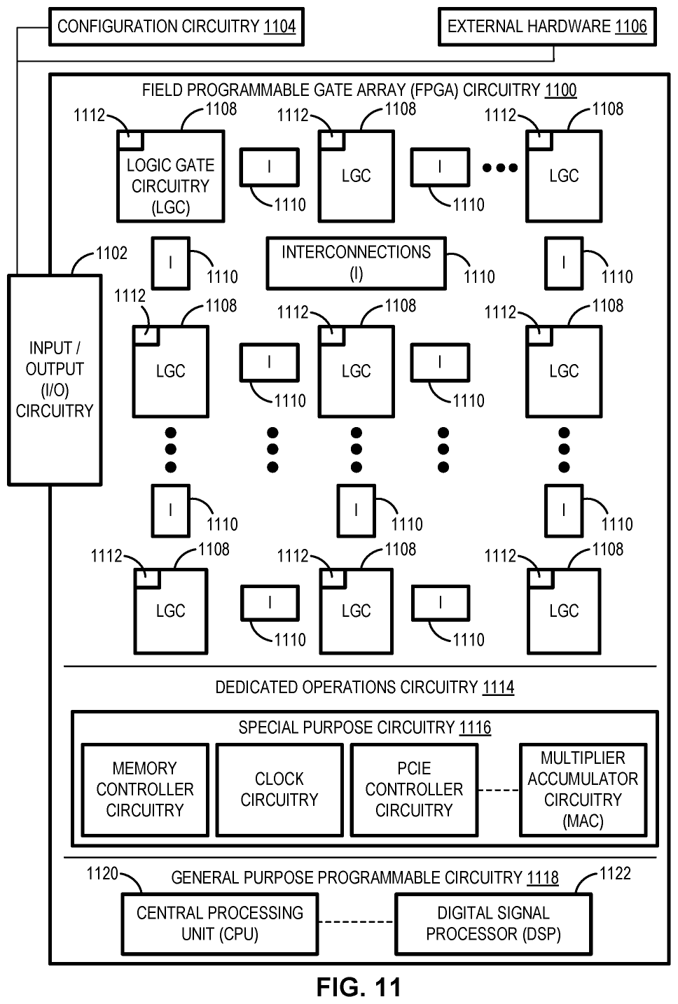

In some examples, the touch device 102A includes means for controlling touch events. For example, the means for controlling touch events may be implemented by touch control circuitry 208A. In some examples, the touch control circuitry 208A may be instantiated by programmable circuitry such as the example programmable circuitry 912 of FIG. 9. For instance, the touch control circuitry 208A may be instantiated by the example microprocessor 1000 of FIG. 10 executing machine executable instructions such as those implemented by at least blocks 502, 504, 510, 602-618, and 708 of FIGS. 5-7. In some examples, the touch control circuitry 208A may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the touch control circuitry 208A may be instantiated by any other combination of hardware, software, and/or firmware. For example, the touch control circuitry 208A may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Within the SoC 206A, the example NIC circuitry 210A of FIG. 2 prepares and manages the exchange of data between the touch device 102A and the network 106. Similarly, within the SoC 206B, the NIC circuitry 210B prepares and manages the exchange of data between the touch device 102B and the network. For example, the NIC circuitry 210A may receive packets from the touch control circuitry 208A or the OS 212A. The NIC circuitry 210A may perform one or more operations corresponding to the packet, including but not limited to re-formatting, encrypting, authenticating, packetizing, etc. In some examples, the NIC circuitry 210A may be implemented as Infrastructure Processor Unit (IPU) circuitry and/or Data Processor Unit (DPU) circuitry.

In some examples, the NIC circuitry 210A and the NIC circuitry 210B exchange touch packets and enable touch synchronization in accordance with the teachings of this disclosure through the use of API (Application Program Interface) calls. As used herein, an API refers to a format of exchanging data between two computer components (e.g., operating system (OS) component, an application, a touch controller, a NIC, etc.). In some examples, an API call is a specific message sent by a first component in a format recognizable by a second component.

API calls used by the example NIC circuitry 210A and/or the example NIC circuitry 210B may include but are not limited to query API calls, enable API calls, disable API calls, etc. For example, the touch device 102B may request touch synchronization with the touch device 102A by transmitting a query API call to the touch device 102A.

In the example of FIGS. 1 and 2, NIC circuitry 210A receives the touch event (e.g., a packet corresponding to the touch event) from the touch monitor circuitry 202A and transmits the touch event (e.g., the touch event packet) to the touch device 102B. In some examples, the NIC circuitry 210A uses an API call when transmitting the touch event. The API call may cause the NIC circuitry 210B to prepare to receive an incoming touch event. In some examples, the API call may additionally or alternatively include the touch event payload data. The NIC circuitry 210A is discussed further in connection with FIG. 3.

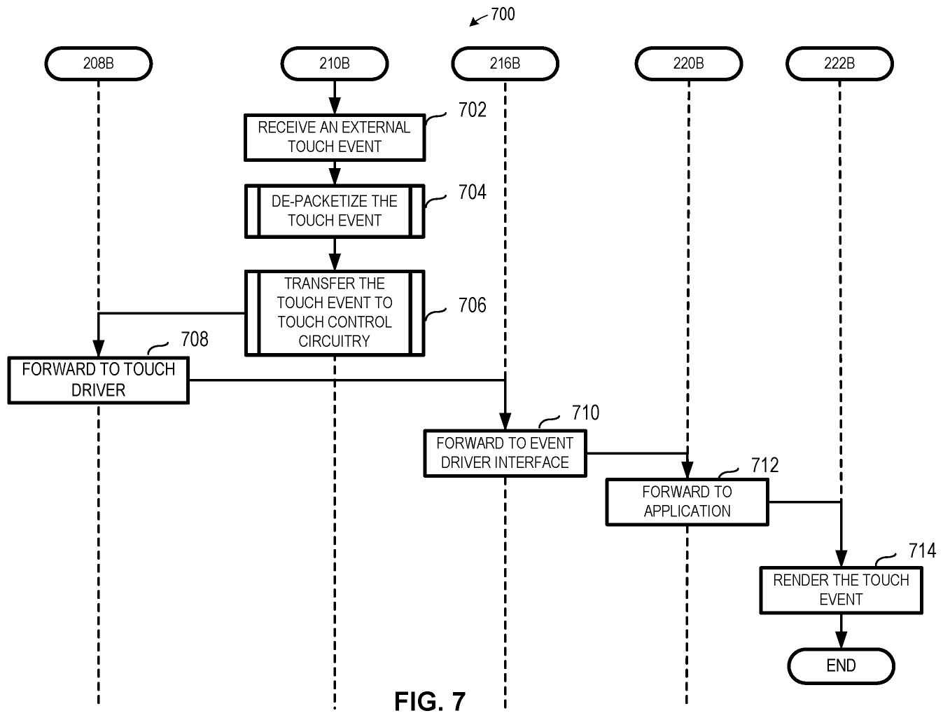

In some examples, the touch device 102A includes means for controlling network packets. For example, the means for controlling network packets may be implemented by NIC circuitry 210A and 210B. In some examples, the NIC circuitry 210A and 210B may be instantiated by programmable circuitry such as the example programmable circuitry 912 of FIG. 9. For instance, the NIC circuitry 210A and 210B may be instantiated by the example microprocessor 1000 of FIG. 10 executing machine executable instructions such as those implemented by at least blocks 702, 704 of FIG. 7. In some examples, the NIC circuitry 210A and 210B may be instantiated by hardware logic circuitry, which may be implemented by an ASIC, XPU, or the FPGA circuitry 1100 of FIG. 11 configured and/or structured to perform operations corresponding to the machine-readable instructions. Additionally or alternatively, the NIC circuitry 210A and 210B may be instantiated by any other combination of hardware, software, and/or firmware. For example, the NIC circuitry 210A and 210B may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example system memory 214A of FIG. 2 stores data utilized by one or more resources within the touch device 102A. For example, the touch device 102A may store touch events in the system memory 214A for access by the OS 212A. Additionally or alternatively, the NIC driver 218A may store a packet in system memory 214A for access by the NIC circuitry 210A. Similarly, the system memory 214B of FIG. 2 stores data utilized by one or more resources within the touch device 102B. The system memory 214A and 214B may be implemented as any type of memory. For example, the system memory 214A and 214B may be volatile memories or non-volatile memories. The volatile memory may be implemented by Synchronous Dynamic Random Access Memory (SDRAM), Dynamic Random Access Memory (DRAM), and/or any other type of RAM device. The non-volatile memory may be implemented by flash memory and/or any other desired type of memory device.

The example OS 212A of FIG. 2 is a software system that manages resources of the touch device 102A. In particular, the OS 212A acts as an interface between user space programs (e.g., the application 222A) and hardware-based modules (e.g., the SoC 206A, the touch monitor circuitry 202A and PHY circuitry 204A). Similarly, the OS 212B of FIG. 2 acts as an interface between user space programs and hardware-based modules. The example OS 212A and 212B may be implemented by any type of operating system, including but not limited to Windows® and Linux®. In some examples, the OS 212A and OS 212B implement different operating systems.

Within the OS 212A, the example touch driver 216A of FIG. 2 is a software program that enables other components of the OS 212A to communicate and manage the touch control circuitry 208A. For example, the touch driver 216A may handle an interrupt caused by the touch control circuitry 208A by creating an input device node to notify the event device interface 220A. Similarly, the touch driver 216B is a software program that enables other components of the OS 212B to communicate and manage the touch control circuitry 208B. In some examples, the touch driver 216A and touch driver 216B are instantiated by programmable circuitry executing touch driver instructions and/or configured to perform operations such as those represented by the flowchart(s) of FIGS. 5-8.

In some examples, the touch device 102A includes means for processing touch events. For example, the means processing touch events may be implemented by touch driver 216A and 216B. In some examples, the touch driver 216A and 216B may be instantiated by programmable circuitry such as the example programmable circuitry 912 of FIG. 9. For instance, the touch driver 216A and 216B may be instantiated by the example microprocessor 1000 of FIG. 10 executing machine executable instructions such as those implemented by at least blocks 512, 710, of FIGS. 5 and 7. In some examples, the touch driver 216A and 216B may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the touch driver 216A and 216B may be instantiated by any other combination of hardware, software, and/or firmware. For example, the touch driver 216A and 216B may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the example of FIG. 2, the NIC driver 218A is a software program that enables other components of the OS 212A to communicate and manage the NIC circuitry 210A. For example, the NIC driver 218A manages transmission descriptor rings and receiver buffer rings that are used to coordinate the exchange of packets with the NIC circuitry 210A. Transmission descriptor rings and receiver buffer rings are discussed further in connection with FIG. 3. Similarly, the NIC driver 218B is a software program that enables other components of the OS 212B to communicate and manage the NIC circuitry 210B. In some examples, the NIC driver 218A and 218B are instantiated by programmable circuitry executing NIC driver instructions and/or configured to perform operations such as those represented by the flowchart(s) of FIGS. 5-8.

The example touch driver 216A and the example NIC driver 218A may utilize API calls to communicate with the event device interface 220 or with one another. Examples of API calls used by the example touch driver 216A and/or the example NIC driver 218A may include but are not limited to query API calls, enable API calls, disable API calls, etc.

Within the OS 212A, the example event device interface 220A responds to events (e.g., an action or occurrence recognized by software) generated by device drivers within the operating system. For example, the event device interface 220A may receive a notification of a touch event and forward the touch event to a compositor. A compositor is a user space program that listens to various input programs within the OS 212A and asks the event device interface 220A for relevant information (e.g., a touch event) when it arrives. In such an example, the compositor identifies the application 222A as having coordinates on the display that correspond to the coordinates of the touch event. The compositor may then forward the touch event to the application 222A.

In some examples, the example application 222A responds to the touch event by generating a packet for an external device (e.g., the touch device 102B). In such examples, the event device interface 220A receives the packet from the application 222A and sends a corresponding instruction to the NIC driver 218A.

The event device interface 220B also responds to events generated by device drivers within the OS 212B. In some examples, one or more of the event device interfaces 220A and 220B may be referred to as an “evdev”. In some examples, the event device interfaces 220A and 220B are instantiated by programmable circuitry executing event interface instructions and/or configured to perform operations such as those represented by the flowchart(s) of FIGS. 5-8.

In some examples, the touch device 102A includes means for processing input events. For example, the means for processing input events may be implemented by event device interface 220A and 220B. In some examples, the event device interface 220A and 220B may be instantiated by programmable circuitry such as the example programmable circuitry 912 of FIG. 9. For instance, the event device interface 220A and 220B may be instantiated by the example microprocessor 1000 of FIG. 10 executing machine executable instructions such as those implemented by at least blocks 514, 712 of FIGS. 5 and 7. In some examples, the event device interface 220A and 220B may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the event device interface 220A and 220B may be instantiated by any other combination of hardware, software, and/or firmware. For example, the event device interface 220A and 220B may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In the example of FIG. 2, the application 222A is a user space program that responds to touch events. Similarly, the application 222B is also a user space program that responds to touch events. As used above and herein, a user space program refers to a software application that interfaces with users and/or implements the application layer of a network protocol stack. In some examples, the applications 222A and 22B responds to touch events by updating a display. In some examples, the application 222A or 222B may implement touch synchronization by using the Precision Time Protocol (PTP) or the User Datagram Protocol (UDP) to exchange packets with another device. The example of FIG. 2 shows one application 222A per touch device 102A. In some example, the touch devices 102 may implement any number of user space programs that respond to touch events. In some examples, the application 222A is instantiated by programmable circuitry executing event interface instructions and/or configured to perform operations such as those represented by the flowchart(s) of FIGS. 5-8.

In some examples, the touch device 102A includes means for rendering a touch event. For example, the means for rendering a touch event may be implemented by application 222A and 222B. In some examples, the application 222A and 222B may be instantiated by programmable circuitry such as the example programmable circuitry 912 of FIG. 9. For instance, the application 222A and 222B may be instantiated by the example microprocessor 1000 of FIG. 10 executing machine executable instructions such as those implemented by at least blocks 516, 714 of FIGS. 5 and 7. In some examples, the application 222A and 222B may be instantiated by hardware logic circuitry, which may be implemented by an ASIC, XPU, or the FPGA circuitry 1100 of FIG. 11 configured and/or structured to perform operations corresponding to the machine readable instructions. Additionally or alternatively, the application 222A and 222B may be instantiated by any other combination of hardware, software, and/or firmware. For example, the application 222A and 222B may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While FIG. 2 refers to the example touch device 102A and touch device 102B, in general, any number of touch devices 102 may include some or all of the components illustrated in FIG. 2 and operate according to the teachings of this disclosure. For example, in FIG. 1, the touch device 102C and touch device 102D also have NIC circuitry that: (a) receive a touch event from the touch device 102A, and (b) transfer the touch event to touch control circuitry.

Some approaches to touch synchronization between devices rely on the traversal of touch events across multiple layers of a network protocol stack. In such approaches, a touch input generated at the touch device 102A would cause data to flow from the touch monitor circuitry 202A to the touch control circuitry 208A, then to the system memory 214A, then to the touch driver 216A, then to the event device interface 220A, then to the application 222A, then back to the event device interface 220A, then to the NIC driver 218A, then to the system memory 214A, then to the NIC circuitry 210A, and then to the PHY circuitry 204A before the information enters the network 106. After traversing the network, data in those approaches traverses the same or similar sequence of components (in reverse order) at the touch device 102B before the touch input is successfully mimicked. The exchange of data between any two components in an electronic device involves some amount of time. For example, an exchange of data between the OS 212A and application 222A is generally slower than an exchange of data between the SoC 206A and OS 212A. Delay compounds across each exchange in the foregoing data path sequence, resulting in some touch synchronization approaches that exhibit latency in the range of milliseconds or seconds.

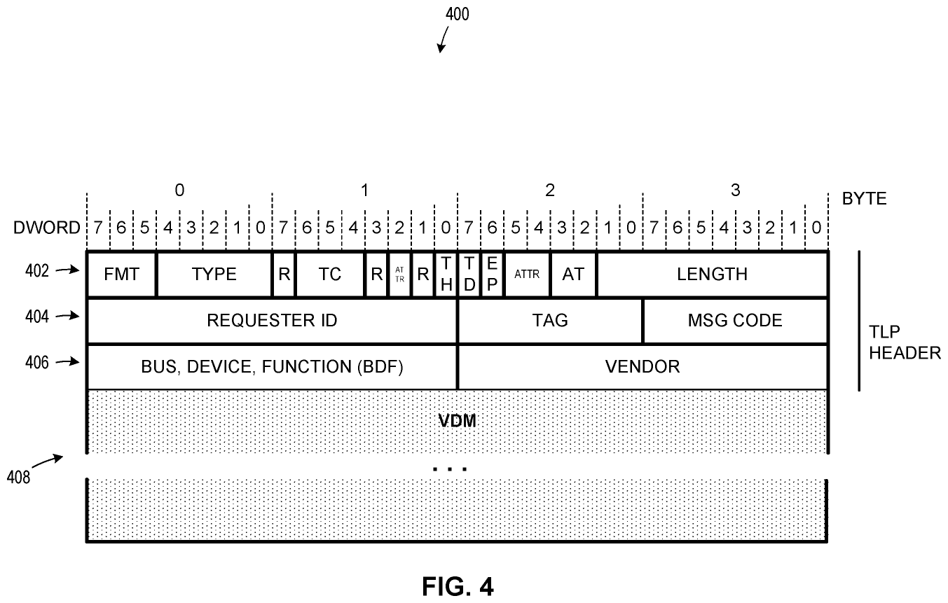

Examples described herein disclose a touch synchronization approach illustrated in FIG. 2 as an example data path 224. In the illustrated example, in the example data path 224, the touch device 102A transmits touch events to the touch device 102B without use of the system memory 214A, the OS 212A, or the application 222A. To do so, the example touch control circuitry 208A and NIC circuitry 210A store touch events in example local buffers and communicate with one another using example Vendor Defined Messages (VDMs). The use of local buffers and VDMs is discussed further in connection with FIG. 4.

The example data path 224 also shows the NIC circuitry 210B using example local buffers and example VDMs to provide the received touch event to the touch control circuitry 208B without the use of the system memory 214B, OS 212B, or application 222B. Because the touch control circuitry 208A processes both external touch event data (from the NIC circuitry 210A) and local touch event data (from the touch monitor circuitry 202A), the example SoC 206A allows the OS 212A and application 222A to treat local touch data and external touch data as indistinguishable. This uniformity in packet processing reduces complexity for any additional operations the OS 212A and application 222A may perform with touch data (e.g., operations other than touch synchronization). Furthermore, by avoiding system memories, operating systems, and user space applications, the teachings of this disclosure can implement the data path 224 with latency in the sub-microsecond scale. Accordingly, the teachings of this disclosure can synchronize with less latency than other approaches, thereby improving performance and user experience.

FIG. 3 is a block diagram of an example implementation of the SoC 206A and system memory 214A of FIG. 2. In the example of FIG. 3, the SoC 206A includes the touch control circuitry 208A, the NIC circuitry 210A, example primary fabric circuitry 312, example sideband fabric circuitry 320, and example Power Management Controller (PMC) Always Running Timer (ART) circuitry 322. In some examples, the NIC circuitry 210A is implemented within the touch device 102A but outside the SoC 206A. The touch control circuitry 208A of FIG. 3 includes example control circuitry 302, example offload engine circuitry 304, example primary interface circuitry 310, example local timer circuitry 314, example message generator circuitry 316, and an example sideband interface circuitry 318. The example offload engine circuitry 304 includes example buffer manager circuitry 306, an example local touch buffer 307, example VDM generator circuitry 308. The NIC circuitry 210A of FIG. 3 includes example primary interface circuitry 311, example PTP timer circuitry 315, example message generator circuitry 317, example sideband interface circuitry 319, example offload engine circuitry 324, example direct memory access (DMA) engine circuitry 338, an example descriptor cache 344, example Medium Access Control (MAC) circuitry 346, and an example packet buffer 348. In the example of FIG. 3, the system memory 214A includes an example receiver decoder ring 340 and an example decoder transmission ring 342. The example offload engine circuitry 324 includes example VDM generator circuitry 326, example buffer manager circuitry 330, an example local NIC buffer 332, example packet processor circuitry 334, and example configuration control registers 336.

Within the touch control circuitry 208A, the example control circuitry 302 of FIG. 3 coordinates touch synchronization within the touch control circuitry 208A in accordance with the teachings of this disclosure. For example, when the touch monitor circuitry 202A generates a touch event, the control circuitry 302 determines which components should be notified of the touch event. The components may be internal to the touch device 102A (e.g., the OS 212A) and/or external to the touch device 102A (e.g., touch device 102B). If touch synchronization is currently enabled, then the control circuitry 302 identifies one or more external devices to notify and forwards the touch event to the buffer manager circuitry 306.

Within the touch control circuitry 208A, the example offload engine circuitry 304 of FIG. 3 enables the exchange of touch events with the NIC circuitry 210A in accordance with the teachings of this disclosure. The offload engine circuitry 304 includes the buffer manager circuitry 306, which controls payloads (e.g., the size and content of packets) sent to the NIC circuitry 210A using the local touch buffer 307. The local touch buffer 307 is an amount of memory within the touch control circuitry 208A that stores the stores touch events. The buffer manager circuitry 306 may determine when to send a packet to the NIC circuitry 210A, how many touch events to include in said packet, etc. For example, if the local touch buffer 307 is not empty when a touch event is received, the buffer manager circuitry 306 may generate a write request to the NIC circuitry 210A. After receiving an acknowledgement request from the NIC circuitry 210A, the buffer manager circuitry 306 then causes transmission of the touch event. If the local touch buffer 307 is empty when a touch event is received, the buffer manager circuitry 306 may write the touch event in the buffer until a threshold number of touch events can be packaged into a single packet.

Within the offload engine circuitry 304, the example VDM generator circuitry 308 enables the transmission of information from the touch control circuitry 208A to the NIC circuitry 210A by generating VDMs. For example, based on instructions from the buffer manager circuitry 306, the VDM generator circuitry 308 forms VDMs that include both the foregoing write request and the touch event itself. When generating a VDM for transmission, the VDM generator circuitry 308 adds a Transaction Layer Packet (TLP) header to the touch data payload in accordance with the teachings of this disclosure. In some examples, the VDM generator circuitry 308 may also receive VDMs from the NIC circuitry 210A via the primary interface circuitry 310. In such examples, the VDM generator circuitry 308 removes the TLP headers from the received VDMs. The example VDM generator circuitry 308 and TLP headers are discussed further in connection with FIG. 4.

The example primary interface circuitry 310 of FIG. 3 enables the touch control circuitry 208A to share data over the primary fabric circuitry 312. Similarly, the example primary interface circuitry 311 enables the NIC circuitry 210A to share data over the primary fabric circuitry 312. The example primary interface circuits 310 and 311 may include any type of hardware components (ports, pins, etc.) to send and receive data over the primary fabric circuitry 312.

The example primary fabric circuitry 312 of FIG. 3 is a communication fabric (e.g., a communication channel) that enables data exchange between connected components. In the example of FIG. 3, the example SoC 206A implements the Intel® On Chip System Fabric (IOSF) protocol. The IOSF protocol is a peripheral component interconnect express (PCIe)-compliant protocol, published by Intel®, that defines three independent communication channels: the primary fabric circuitry 312, the sideband fabric circuitry 320, and a debugging fabric. The IOSF protocol defines the primary fabric circuitry 312 to implement data exchange at higher speeds than the sideband fabric circuitry 320. Accordingly, some components may reserve usage of the primary fabric circuitry 312 for high priority data. In other examples, the communication fabric within the SoC 206A uses one or more protocols other than IOSF to exchange data between the touch control circuitry 208A and the NIC circuitry 210A. In some examples, the touch control circuitry 208A, the NIC circuitry 210A, and/or other components in the SoC 206A use a communication fabric to exchange API calls with one another.

In some examples, the exchange of information over the primary fabric circuitry 312 is referred to as in-band communication. In such examples, the transmission of a VDM by the touch control circuitry 208A may be referred to as in-band message. As used above and herein, fabric circuitry may be implemented by any components that transmit electrical signals (e.g., a wire, a bus, an interconnect, a Printed Circuit Board (PCB) trace, etc.).

As used above and herein, a VDM refers to a message within a communication protocol whose contents and format are defined by the vendors (e.g., entities using the protocol) rather than the authors of the protocol. While a communication protocol may be designed to support a first functionality by defining a first message format, the use of VDMs enable the communication protocol to expand support to additional functionality defined by a third party (e.g., the vendor). For example, the primary fabric circuitry 312 of FIG. 3 may not exchange VDM messages exclusively. Rather, other components within the touch device 102A may use the primary fabric circuitry 312 to exchange messages unrelated to touch synchronization. Such messages may be generated by any component connected to the primary fabric circuitry 312 and may contain any type of information.

Within the touch control circuitry 208A, the control circuitry 302 includes the local timer circuitry 314. The example local timer circuitry 314 of FIG. 3 generates a clock pulse that is utilized by the message generator circuitry 316. The example message generator circuitry 316 of FIG. 3 produces messages that describe or characterize the clock signal of the touch control circuitry 208A. Similarly, the example message generator circuitry 317 uses the PTP timer circuitry 315 to produce messages that describe or characterize the clock signal of the NIC circuitry 210A.

The example sideband interface circuitry 318 enables the touch control circuitry 208A to share data over the sideband fabric circuitry 320. Similarly, the example sideband interface circuitry 319 enables the NIC circuitry 210A to share data over the sideband fabric circuitry 320. The example sideband interface circuits 318 and 319 may include any type of hardware components (ports, pins, etc.) required to send and receive data over the sideband fabric circuitry 320.

The example sideband fabric circuitry 320 is a communication channel that enables data exchange between connected components. In some examples, the IOSF protocol defines the sideband fabric circuitry 320 to implement data exchange at lower speeds than the primary fabric circuitry 312. Accordingly, some components may utilize the sideband fabric circuitry 320 to exchange low priority data. In some examples, the exchange of information over the sideband fabric circuitry 320 is referred to as side-band communication.

In the example of FIG. 3, both the touch control circuitry 208A and the NIC circuitry 210A use the sideband fabric circuitry 320 to exchange a local clock signal and a PTP clock signal, respectively. By sharing clock signals, the foregoing components can utilize the PTP protocol to negotiate a synchronous clock signal. In the example of FIG. 3, the message generator circuits 316 and 317 cross timestamp the outputs of the local timer circuitry 314 and the PTP timer circuitry 315 with the output of the PMC ART circuitry 322 to perform correlation and correction operations, thereby forming the synchronous clock signal. In other examples, the message generator circuits 316 and 317 may implement a different technique to synchronize local clock signals.

The synchronous clock signal is a shared reference that is used by the touch control circuitry 208A and the NIC circuitry 210A to align touch operations in time. For example, if the touch control circuitry 208A agrees to send a touch event at clock cycle x of the synchronous clock signal and the NIC circuitry 210A agrees to receive a touch event at clock cycle x of the same synchronous clock signal, then both components are referring to the same point in time. In contrast, if the touch control circuitry 208A sends a touch event at timestamp y of a clock signal local to the touch control circuitry 208A, and the NIC circuitry 210A was configured to receive a touch event at timestamp y of clock signal local to the NIC circuitry 210A, a difference between the two clock signals may cause transmission error and/or latency.

The PMC ART circuitry 322 produces a continuously running clock signal. The PMC ART circuitry 322 may be used by other power management circuitry components to manage power down events and low power states within the touch control circuitry 208A and/or NIC circuitry 210A.

The PMC ART circuitry 322 connects to other components within the touch device 102A via the sideband fabric circuitry 320. Accordingly, the message generator circuits 316 and 317 can also access the continuous clock signal generated by the PMC ART circuitry 322 to perform clock synchronization operations as discussed above.

Within the NIC circuitry 210A, the example offload engine circuitry 324 of FIG. 3 enables the exchange of touch events with the touch control circuitry 208A and the network 106 in accordance with the teachings of this disclosure. The offload engine circuitry 324 includes the example VDM generator circuitry 326, which exchanges VDMs with the touch control circuitry 208A via the primary fabric circuitry 312 and primary interface circuitry 311.

The VDM generator circuitry 326 may send or receive VDMs to enable any type of communication with the touch control circuitry 208A. For example, the VDM generator circuitry 326 may receive a write request from the touch control circuitry 208A and forward the write request to the buffer manager circuitry 330. If the buffer manager circuitry 330 determines a local NIC buffer 332 has capacity to store the described touch events, the VDM generator circuitry 326 may send the touch control circuitry 208A an acknowledgement request as a VDM. In such examples, the VDM generator circuitry 326 then receives a packet of touch events within a VDM. The VDM generator circuitry 326 strips away headers specific to a communication fabric (e.g., the TLP header) from the VDM to obtain the underlying payload of touch data and provides the payload to the buffer manager circuitry 330 for storage in the local NIC buffer 332. In some examples, if the NIC circuitry 210A receives an external touch packet from the network 106, the VDM generator circuitry 326 may inform the touch control circuitry 208A and subsequently forward the packet by forming one or more VDMs with TLP headers.

Within the offload engine circuitry 324, the buffer manager circuitry 330 manages the contents of the local NIC buffer 332. As used above and herein, the local NIC buffer 332 is an amount of memory within the NIC circuitry 210A that stores the stores touch events. In the foregoing example, the buffer manager circuitry 330 determines when the local NIC buffer 332 has adequate space to receive additional touch packets and when to provide an acknowledgement response. If space in the local NIC buffer 332 is available, the buffer manager circuitry 330 may send an acknowledgement response as soon as a write request is received and processed. If space in the local NIC buffer 332 is not immediately available, the buffer manager circuitry 330 may instruct the touch control circuitry 208A to wait to send the touch events. The buffer manager circuitry 330 may additionally determine when to send touch events over the network 106, how many touch events to include within a network packet, etc.

Within the offload engine circuitry 324, the packet processor circuitry 334 prepares packets of touch data for transmission over the network. For example, the packet processor circuitry 334 may add network headers to the start of a packet, add a virtual local area network (VLAN) identification tag to the payload of a packet, and inform the DMA engine circuitry 338 a packet is ready for transmission. Examples of network headers include but are not limited to Transmission Control Protocol (TCP) headers, Internet Protocol (IP) headers, and Media Access Control (MAC) headers, etc. As used herein, a VLAN identification tag refers to a value that identifies and distinguishes packets containing touch data from other packets that NICs of external devices (e.g., the NIC circuitry 210B of the touch device 102B) may receive.

The configuration control registers 336 refer to an amount of memory in the NIC circuitry 210A that stores data used by the packet processor circuitry during the formation of the pre-defined network headers. Examples of data stored in the configuration control registers 336 may include but is not limited to the source address of the NIC circuitry 210A, the destination addresses of devices that receive touch packets as part of touch synchronization, whether the packets are being sent synchronously or synchronously, etc.

Within the NIC circuitry 210A, the DMA engine circuitry 338 generates DMA requests to access memory. The DMA requests may be to obtain outgoing touch data for transmission over the network 106, or to store incoming touch data that was received over the network 106. The DMA engine determines which memory source within the touch device 102A should receive a DMA request based on the receiver decoder ring 340 and decoder transmission ring 342.

The example receiver decoder ring 340 and decoder transmission ring 342 of FIG. 3 are data structures utilized by the DMA engine circuitry 338 to make DMA requests. A ring data structure may be formed using any amount of data. In the example of FIG. 3, the descriptors are four double words (e.g., 128 bits) in size. Two of the double words store pointers that identify memory addresses within the touch device 102A. When obtaining outgoing touch events for transmission over the network 106, the DMA engine circuitry 338 parses the decoder transmission ring 342 to obtain the pointer and determine which memory address stores the outgoing touch event data. Similarly, after receiving incoming touch events from the network 106, the DMA engine circuitry 338 parses the receiver decoder ring 340 to obtain the pointer and determine which memory address the incoming touch data should be written to.

In addition to pointers, ring data structures also include configuration parameters that describe how touch data corresponding to the ring data structure should be transmitted or received over the network 106. For example, a first parameter within the data structure may include timing information (e.g., when an outgoing touch packet should be sent, or when the NIC circuitry 210A should anticipate receiving an incoming packet). As another example, a second parameter within the data structure may describe the amount of data to be transmitted or received (e.g., how many rows following the identified memory address will be utilized). In some examples, ring data structures contain a different amount of configuration parameters and/or different types of information.

In some approaches to synchronize touch events, both outgoing touch events and incoming touch events are stored within system memory for access by operating systems and user space applications. Accordingly, the NIC driver 218A forms the receiver decoder ring 340 and decoder transmission ring 342 to initially refer to various addresses within system memory 214A. In some approaches, the DMA engine circuitry 338 may: (a) access the receiver decoder ring 340 and decoder transmission ring 342 via the primary fabric circuitry 312, and (b) use the receiver decoder ring 340 and decoder transmission ring 342 to access materials in system memory 214A.

However, the descriptor cache 344 of the illustrated example is encoded with instructions that cause the DMA engine circuitry 338 to modify a copy of the receiver decoder ring 340 and a copy of the decoder transmission ring 342 before parsing and utilizing the data structures. For example, the descriptor cache 344 causes the DMA engine circuitry 338 to add an extra configuration parameter (e.g., an extra field) to each ring data structure that indicates the pointer refers to the local NIC buffer 332 rather than the system memory 214A. The descriptor cache 344 also causes the DMA engine circuitry 338 to modify the pointer to refer to the appropriate memory address in the local NIC buffer 332.

After the example DMA engine circuitry 338 completes the modification of a copy of the ring data structure based on the descriptor cache 344, the DMA engine circuitry 338 can then parse and utilize the modified ring data structures. For example, when the DMA engine circuitry 338 forms a DMA request to access outgoing touch data or store incoming touch data, the modifications cause the DMA engine circuitry 338 to send the DMA request to the buffer manager circuitry 330 (which subsequently interfaces with the local NIC buffer 332). As a result, the example touch control circuitry 208A and the example NIC circuitry 210A can limit memory accesses to occur within the SoC 206A during touch synchronization, thereby avoiding system memory 214A, the OS 212A, and the application 222A.

The example MAC circuitry 346 of FIG. 3 implements a part of the data link layer of a network protocol stack. For example, the MAC circuitry 346 may control the PHY circuitry 204A by performing data flow and/or multiplexing operations. In the example of FIG. 1, the MAC circuitry 346 implements one or more portions of the Institute of Electrical and Electronics Engineers (IEEE) 802.3 Ethernet specifications and IEEE 802.1 Time Sensitive Networking (TSN) specifications.

The example of FIG. 3 shows that, to implement the example data path 224 of FIG. 2, the offload engine circuits 304 and 324 (of the touch controller circuitry 208A and NIC circuitry 210A, respectively) may communicate with one another to receive a local touch event from the touch monitor circuitry 202A, package the touch event into a packet containing VDMs and TLP headers, exchange the packet via the primary fabric circuitry 312, reformat the packet to remove the TLP header and add network headers, and send the packet over the network 106. In some examples of the data path 224 of FIG. 2, the offload engine circuits 304 and 324 may communicate with one another to receive an external local touch event from the network 106, ref-format the packet to remove the network headers and add a TLP header, exchange the packet via the primary fabric circuitry 312, and remove the TLP header, and subsequently process the external touch device (e.g., to cause a display to update).

In some examples, to reduce (e.g., minimize) the time between the generation of a touch input on a first touch device and the mimicking of the touch input on the second device, examples disclosed herein exchange touch data between the touch control circuitry 208A and NIC circuitry 210A using a communication fabric that supports prioritized messaging. In some such examples, the touch control circuitry 208A and the NIC control circuitry 210 use TSN algorithms to exchange touch data in express packets that traverse the primary fabric circuitry 312. Examples of TSN algorithms include but are not limited to the algorithms defined in the Institute of Electrical and Electronics Engineers (IEEE) 802.1Qav and 802.1Qbv specifications (published in 2009 and 2015, respectively).

The use of TSN algorithm to schedule VDMs over the primary fabric circuitry 312, and the use of local buffers (e.g., the local touch buffer 307 and local NIC buffer 332), enable implementation of the example data path 224 in the sub-microsecond range. In contrast, other approaches for touch synchronization that use system memory, operating systems, and user space applications are limited to data paths that can be implemented in the millisecond or second range. Accordingly, examples disclosed herein can synchronize touch events with less latency than other approaches, thereby improving performance and user experience. In some examples, the touch control circuitry 208A and NIC circuitry 210A exchange information using VDMs within a protocol other than IOSF.

While the examples of FIGS. 1 and 2 describe the example data path 224 within the context of touch synchronization, the teachings of this disclosure may apply to any type of hardware resource that exchanges event data between the NIC circuitry 210A. For example, suppose a camera module within the SoC 206A generates gesture data based on inputs from a camera sensor. In such examples, the camera module may: (a) package the gesture data into VDM packets with TLP headers, and (b) use TSN scheduling to transmit the VDM packets over the primary fabric circuitry 312. Similarly, the NIC circuitry 210A in such examples may remove the TLP header, add network headers, and send the packet over the network 106. In doing so, the SoC 206A reduces latency by transmitting gesture data to other devices intermediate storage in the system memory 214A, the use of the OS 212A, or the use of the application 222A.

Other types of hardware module may reduce latency by using the teachings of this disclosure. For example, such a hardware module may be a user interface controller or user interface control circuitry that obtains local event data based on detection of a user input (from, for example, a touch panel, a camera, etc.), and prepares the data for transmission to the NIC circuitry 210A. Similarly, the NIC circuitry 210A may: (a) obtain external event data from any type of user interface controller implemented on an external device, (b) use the teachings of this disclosure to forward the external event data to a local user interface controller of the same type.

FIG. 4 is a block diagram of an example VDM 408 that may be used by the SoC 206A of FIG. 3. FIG. 4 illustrates the example VDM 408 as included in an example packet 400. The example packet 400 includes example double words 402, 404, 406, and the example VDM 408.

The packet 400 of FIG. 4 is an example of one unit of data that may be exchanged between the touch control circuitry 208A and the NIC circuitry 210A in accordance with the teachings of this disclosure. The packet 400 is an example implementation of a TLP. A TLP is a type of packet within the PCIe protocol that are used by devices to exchange information.

The example double words 402, 404, 406 collectively form a TLP header. The TLP header can be subdivided into various fields that contain metadata corresponding to the TLP. For example, the “FMT” field within the zeroth byte of double word 402 describes the length of the header and whether a data payload is present. In the example of FIG. 4, the data payload is present within the TLP and is represented as the VDM 408 and.

The “TYPE” field within the zeroth byte of double word 402 describes the type of the TLP (e.g., memory read, memory write, I/O read, I/O write, message, completion, etc.). In the example of FIG. 4, the type of TLP that implements the packet 400 may vary based on when the packet 400 is sent within the data path 224 of FIG. 2. For example, a TLP that requests permission to perform a write operation may have a different type than a TLP that contains touch data.

The “LENGTH” field within the second and third bytes of double word 402 describes the length of the payload (e.g., the VDM 408). The payload of a TLP may be anywhere from 0 to 1023 double words, depending on the type of TLP and the contents of the payload. In the example of FIG. 4, the VDM 408 may be implemented at any size between 1 and 1023 double words.

The VDM 408 contains data corresponding to one or more touch events. In some examples, the VDM 408 contains the touch events themselves: that is, data describing when touches occurred, the types of touches that occurred, the coordinates of the touches, etc. In some examples, the VDM 408 contains one or more messages used to negotiate the exchange of touch events (e.g., a request to write touch data, an acknowledgement that gives permission to perform the write operation, a back pressure message informing a transmitter device that a receiver device is too busy or does not have adequate storage to currently accept a write operation, etc.). Accordingly, the touch control circuitry 208A and the NIC circuitry 210A may change the format of the VDM 408 depending on the type of information transmitted within the payload of a particular TLP.

While an example manner of implementing the touch device 102A of FIG. 1 is illustrated in FIGS. 2 and 3, one or more of the elements, processes, and/or devices illustrated in FIGS. 2 and 3 may be combined, divided, re-arranged, omitted, eliminated, and/or implemented in any other way. Further, the touch monitor circuitry 202A, the PHY circuitry 204A, the touch control circuitry 208A, the NIC circuitry 210A, the system memory 214A, the touch driver 216A, the NIC driver 218A, the event device interface 220A, the application 222A, and/or, more generally, the example touch device 102A of FIGS. 2 and 3, may be implemented by hardware alone or by hardware in combination with software and/or firmware. Thus, for example, any of the touch monitor circuitry 202A, the PHY circuitry 204A, the touch control circuitry 208A, the NIC circuitry 210A, the system memory 214A, the touch driver 216A, the NIC driver 218A, the event device interface 220A, the application 222A, and/or, more generally, the example touch device 102A, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example touch device 102A of FIGS. 2 and 3 may include one or more elements, processes, and/or devices in addition to, or instead of, those illustrated in FIGS. 2 and 3, and/or may include more than one of any or all of the illustrated elements, processes and devices.

Flowchart(s) representative of example machine readable instructions, which may be executed by programmable circuitry to implement and/or instantiate the touch device 102A of FIGS. 2 and 3 and/or representative of example operations which may be performed by programmable circuitry to implement and/or instantiate the touch device 102A of FIGS. 2 and 3, are shown in FIGS. 5-8. The machine readable instructions may be one or more executable programs or portion(s) of one or more executable programs for execution by programmable circuitry such as the programmable circuitry 912 shown in the example programmable circuitry platform 900 discussed below in connection with FIG. 9 and/or may be one or more function(s) or portion(s) of functions to be performed by the example programmable circuitry (e.g., an FPGA) discussed below in connection with FIGS. 10 and/or 11. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 5-8, many other methods of implementing the example touch device 102A may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine readable, computer readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 5-8 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine readable medium, and/or non-transitory machine-readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or operations 500 that may be executed, instantiated, and/or performed by the touch device 102A of FIG. 2 to transmit a synchronized touch event. The example flowchart of FIG. 5 shows five columns of blocks that include reference numerals from FIG. 2. Accordingly, blocks in the “208A” column are implemented by the example touch control circuitry 208A, blocks in the “210A” column are implemented by the example NIC circuitry 210A, blocks in the “216A” column are implemented by the example touch driver 216A, blocks in the “220A” column are implemented by the example event device interface 220A, and blocks in the “222A” column are implemented by the application 222A.

The example machine-readable instructions and/or the example operations 500 of FIG. 5 begin when the touch control circuitry 208A receives a local touch event. (Block 502). The local touch event refers to data generated within the touch device 102A (e.g., by the touch monitor circuitry 202A) that describes the input 104.

In response to receiving the local touch event, the touch device 102A executes two data paths in parallel. One such path is part of the example data path 224 of FIG. 2. In the example flowchart of FIG. 5, the role of the touch device 102A within the data path 224 is represented by blocks 504-508.

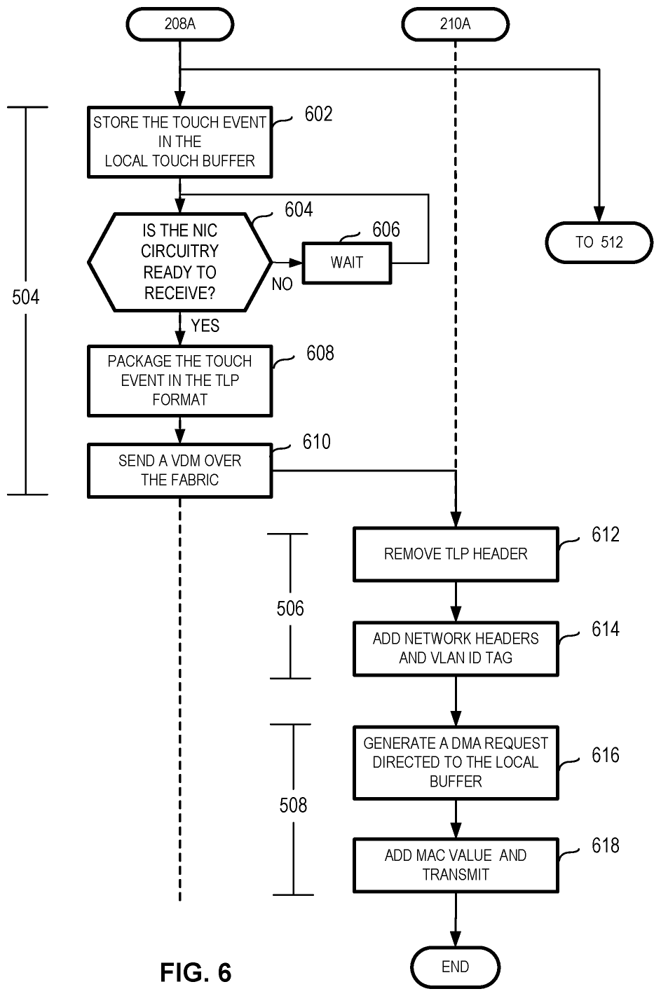

The touch control circuitry 208A forwards the touch event to the NIC circuitry 210A. (Block 504). The transmission of synchronized touch data between the touch control circuitry 208A and the NIC circuitry 210A occurs within the SoC 206A, thereby avoiding the OS 212A and the application 222A. Block 504 is discussed further in connection with FIG. 6.

The NIC circuitry 210A packets the received touch event to prepare the data for transmission to an external device (e.g., the touch device 102B). (Block 506). The NIC circuitry 210A then sends the packet over the network 106. (Block 508). After sending the packet over the network 106, the role of the touch device 102A within the data path 224 ends.

In the example of FIG. 5, the second parallel data path is represented by block 510-516. In response to the touch event received at block 502, the touch control circuitry 208A also forwards the touch event to the touch driver 216A. (Block 510). To do so, the touch control circuitry 208A stores a copy of the touch event data in the system memory 214, where the data is accessible by the touch driver 216A. The touch control circuitry 208A may additionally generate an interrupt at block 510 to inform the touch driver 216A of the presence of the touch event data in system memory 214A.a

The touch driver 216A of FIG. 2 obtains the touch event from system memory 214A and forwards the touch event to the event device interface 220A. (Block 512). The touch driver 216A may use one or more API calls to forward the touch event to the event device interface 220A.

The event device interface 220A forwards the touch event to the application 222A. (Block 514). To do so, the event device interface 220A first provides the touch event to a compositor program that identifies the application 222A as having coordinates on the display that correspond to the coordinates of the touch event. The compositor program then provides the touch event to the application 222A. The event device interface 220A and/or the compositor program may use one or more API calls to forward the touch event to the application 222A.

The application 222A renders the touch event on a display. (Block 516). To render the touch event, the application 222A interprets the touch event within the context of the display at the time the input 104 was made. In the example of FIG. 1, the application 222A performs an annotation (e.g., draws a portion of the letter ‘Y’) in response to the input 104. In other examples, application 222A may render the display based on other interpretations of the touch event. Such interpretations may result in the movement of a mouse, the opening or closing of a window, etc. The second data path of the example machine-readable instructions and/or the example operations 500 ends after block 516.

The example of FIG. 5 shows how the touch device 102A may perform operations to synchronize the touch event with another device (e.g. implement blocks 504-508) in parallel with operations to render the touch event on a display of the touch device 102A itself (e.g., blocks 510-516). As such, the touch device 102A can reduce the overall time to both render a touch event and synchronize the touch event with another device.

FIG. 6 is a flowchart representative of example machine readable instructions and/or example operations that may be executed, instantiated, and/or performed by example programmable circuitry to forward a touch request to the NIC circuitry 210A, packetize the touch request, and send the packet over the network as described in FIG. 5. That is, the example flowchart of FIG. 6 is an example implementation of blocks 504, 506, and 508 of FIG. 5. In the illustrated example, blocks 602-610 of FIG. 6 correspond to block 504 of FIG. 5, blocks 612 and 614 of FIG. 6 correspond to block 506 of FIG. 5, and blocks 616 and 618 of FIG. 6 correspond to block 508 of FIG. 5. Like FIG. 5, the example of flowchart of FIG. 6 is separated into columns that are labelled with reference numerals from FIG. 2. Accordingly, blocks in the “208A” column are implemented by the example touch control circuitry 208A and blocks in the “210A” column are implemented by the example NIC circuitry 210A.

After the control circuitry 302 receives the local touch event in block 502 of FIG. 5, the buffer manager circuitry 306 stores the touch event in the local touch buffer 307. (Block 602). The buffer manager circuitry 306 then determines if the NIC circuitry 210A is ready to receive the touch packet. (Block 604). To make the determination of block 504, the buffer manager circuitry 306 instructs the VDM generator circuitry 308 to send a VDM containing a write request to the NIC circuitry 210A and then waits for a response. The NIC circuitry 210A may respond by sending an approval message to the touch control circuitry 208A, or by instructing the touch control circuitry 208A to wait to transmit. The NIC circuitry 210A may be unable to receive touch data at a particular point in time for any reason.

If the NIC circuitry 210A is not ready to receive a touch packet (Block 604: No), the buffer manager circuitry 306 may wait for a period (Block 606) before making an additional inquiry to the NIC circuitry 210A at block 604. If the NIC circuitry 210A is ready to receive a touch packet (Block 604: Yes), the VDM generator circuitry 308 packages the touch event into the TLP format. (Block 608). The contents and format of the TLP are discussed above in connection with FIG. 4.

The primary interface circuitry 310 transmits a VDM over a communication fabric. (Block 610). In particular, the primary interface circuitry 310 uses the primary fabric circuitry 312 to transmit the TLP of block 608. The payload of the TLP is a VDM that includes one or more touch events. The primary interface circuitry 310 uses a TSN algorithm to schedule the transmission of the TLP as described above.

Upon receiving the TLP over the primary fabric circuitry 312, the VDM generator circuitry 326 of the NIC circuitry 210A removes the TLP header from the TLP. (Block 612). As described above, the TLP header contains metadata describing the TLP and is separate from the VDM. The buffer manager circuitry 330 also stores the VDM in the local NIC buffer 332 at block 612.

The packet processor circuitry 334 adds network headers and a VLAN identification tag to the VDM. (Block 614). The network headers enable various devices within the network 106 to route the packet to the proper destination (e.g., the touch device 102B) while the VLAN identification tag distinguishes packets containing touch events from other network traffic.

The DMA engine circuitry 338 uses a modified decoder transmission ring 342 to generate a DMA request directed to the local NIC buffer 332. (Block 616). As described above, the decoder transmission ring 342 of FIG. 3 is modified to refer to the local NIC buffer 332 based on instructions within the descriptor cache 344. The DMA engine circuitry 338 may modify the descriptor cache 344 at any time before generating the DMA request of block 616.

In some examples, the packet processor circuitry 334 adds a message authentication code (MAC) value to the packet before providing the packet to PHY circuitry 204A for transmission over the network 106. (Block 618). The MAC value enables other devices (e.g., the touch device 102B) to authenticate the packet and determine whether the touch event data contains any errors from transmission. The role of the touch device 102A within the data path 224 ends after block 618 or block 616.

FIG. 7 is a flowchart representative of example machine readable instructions and/or example operations 700 that may be executed, instantiated, and/or performed by example programmable circuitry to implement the touch device 102B of FIG. 2. In the illustrated example, the example flowchart of FIG. 7 describes operations performed by the example touch device 102B of FIG. 2 to mimic external touch input using the teachings of this disclosure. Like FIG. 5, the example flowchart of FIG. 7 shows five columns of blocks that include reference numerals from FIG. 2. Accordingly, blocks in the “208B” column are implemented by the example touch control circuitry 208B, blocks in the “210B” column are implemented by the example NIC circuitry 210B, blocks in the “216B” column are implemented by the example touch driver 216B, blocks in the “220B” column are implemented by the example event device interface 220B, and blocks in the “222B” column are implemented by the application 222B.

The example machine readable instructions and/or example operations 700 begin when the NIC circuitry 210B receives an external touch event (e.g., a touch event representative of the input 104). (Block 702). The touch event data is received by the NIC circuitry 210B via the PHY circuitry 204B and the network 106. The touch data is packaged within a TLP as discussed above.

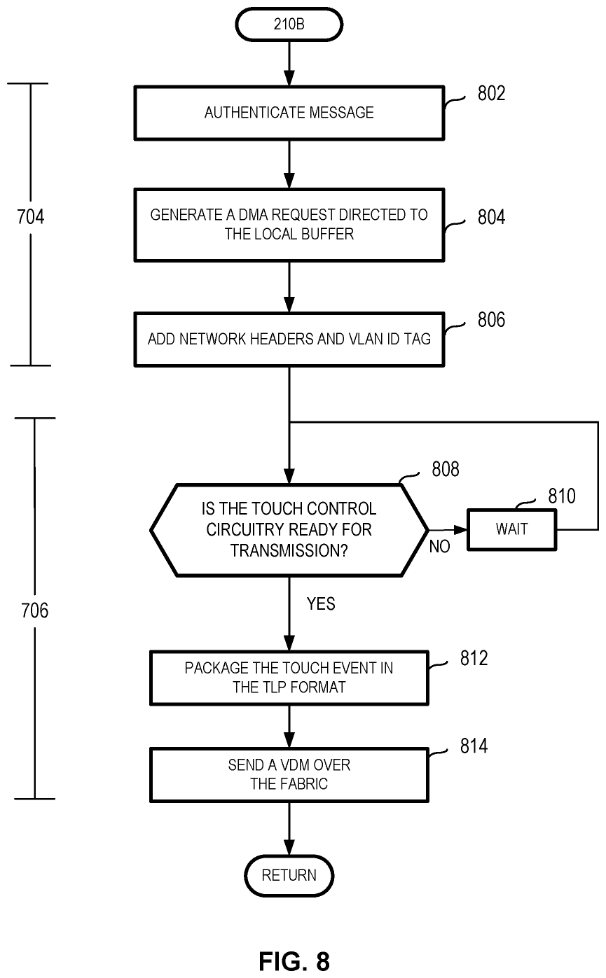

The NIC circuitry 210B de-packetizes the touch event data. (Block 704). That is, the operations of block 704 extract the touch event data from the TLP and stores the touch event data within the NIC circuitry 210B for additional processing. Block 704 is discussed further in FIG. 8.

The NIC circuitry 210B transfers the touch event data to the touch control circuitry 208B. (Block 706). The transmission of synchronized touch data between the NIC circuitry 210B and the touch control circuitry 208B occurs within the SoC 206B, thereby avoiding the OS 212B and the application 222B. Block 706 is discussed further in connection with FIG. 8.

The role of the touch device 102B within the example implementation of the data path 224 ends at block 706. In total, the foregoing implementation of the data path 224 (e.g., where the touch device 102A sends a touch event to touch device 102B) is represented in FIGS. 5 and 7 by blocks 504-508 and blocks 702-706. In addition to the example data path 224, the touch devices 102 may implement other touch synchronization data paths in accordance with the teachings of this disclosure. For example, in FIG. 1, the touch device 102A additionally sends a touch event describing the input 104 to the touch device 102C and 102D. Furthermore, any of the touch devices 102 may receive a touch event from one or more external devices.

After the touch control circuitry 208B receives the touch event from the NIC circuitry 210B, the touch device 102B implements the second data path of FIG. 5 to render the touch event on a display. That is, blocks 708-714 of FIG. 7 refer to the same operations as blocks 510-516 of FIG. 5. In particular, the touch control circuitry 208B forwards the touch event to the touch driver 216B (Block 708), the touch driver 216B forwards the touch event to the event device interface 220B (Block 710), the event device interface 220B forwards the touch event to the application 222B via a compositor program (Block 712), and the application 222B renders the touch event to a display (Block 714). In the illustrated examples, the similarity of blocks 510-516 (e.g., operations to render a local touch event on a display) and blocks 708-714 (e.g., operations to render an external touch event on a display) enable operations systems and applications that interface with the example touch control circuitry and example NIC circuitry described herein to avoid the need to distinguish between local and external touch events, thereby reducing complexity compared to other approaches.

FIG. 8 is a flowchart representative of example machine readable instructions and/or example operations that may be executed, instantiated, and/or performed by example programmable circuitry to de-packetize an external touch request, and send the touch event to the touch control circuitry 208B as described in FIG. 7. That is, the example flowchart of FIG. 8 is an example implementation of blocks 704 and 706 of FIG. 7. In particular, blocks 802-808 of FIG. 8 correspond to block 704 of FIG. 7, and blocks 810-814 of FIG. 8 correspond to block 706 of FIG. 7. The example flowchart of FIG. 7 is labelled with the reference numeral “210B” because blocks 802-814 are implemented by various components of the NIC circuitry 210B.

In some examples, after the PHY circuitry 204B receives a packet from the network 106, the NIC circuitry 210B within the touch device 102B authenticates the packet. (Block 802). To do so, the NIC circuitry 210B executes an authentication algorithm to produce a MAC value and compares the produced MAC value to the MAC value within the packet.

The DMA engine circuitry 338 within the touch device 102B uses a VLAN identification tag within the packet to identify the packet as containing touch event data. Based on the determination, the DMA engine circuitry 338 within the touch device 102B uses a modified copy of the decoder transmission ring 342 to generate a DMA request directed to the local NIC buffer 332. (Block 804).

As described above in connection with FIG. 3, the DMA engine circuitry 338 modifies a copy of the decoder transmission ring 342 to refer to the local NIC buffer 332 of the touch device 102B based on instructions within the descriptor cache 344. The DMA engine circuitry 338 may modify a copy of the decoder transmission ring 342 at any time before generating the DMA request of block 804. The DMA request of block 804 causes the buffer manager circuitry 330 to store the packet in the local NIC buffer 332. In some examples, if the NIC circuitry 210A receives a message without the VLAN identification tag (e.g., a message unrelated to touch synchronization), the DMA engine circuitry 338 may use the original version of the decoder transmission ring 342 to access data in system memory 214A and transmit said data.

The packet processor circuitry 334 of the touch device 10B removes network headers and the VLAN identification tag from the packet. (Block 806). While the network headers and VLAN identification tag are used by the NIC circuitry 210B to communicate with the network 106, the foregoing network parameters are not needed for communication with the touch control circuitry 208B.

The buffer manager circuitry 330 within the NIC circuitry 210B determines if the touch control circuitry 208B is ready to receive the touch packet. (Block 808). To make the determination of block 808, the buffer manager circuitry 330 instructs the VDM generator circuitry 326 to send a VDM containing a write request to the touch control circuitry 208B and then waits for a response. The touch control circuitry 208B may respond by approving the write request or by instructing the NIC circuitry 210B to wait to transmit. The touch control circuitry 208B may be unable to receive touch data at a particular point in time for any reason.

If the touch control circuitry 208B is not ready to receive a touch packet (Block 808: No), the buffer manager circuitry 330 may wait for a period (Block 810) before making an additional inquiry to the touch control circuitry 208B at block 808. If the touch control circuitry 208B is ready to receive a touch packet (Block 808: Yes), the VDM generator circuitry 326 packages the touch event into the TLP format. (Block 812). The contents and format of the TLP are discussed above in connection with FIG. 4.

The primary interface circuitry 311 transmits a VDM over a communication fabric. (Block 814). For example, the primary interface circuitry 310 uses the primary fabric circuitry 312 to transmit the TLP of block 812. The payload of the TLP is a VDM that includes one or more touch events. The primary interface circuitry 311 uses a TSN algorithm to schedule the transmission of the TLP as described above. The example machine readable instructions and/or operations 700 return to block 708 after block 814.

FIG. 9 is a block diagram of an example programmable circuitry platform 900 structured to execute and/or instantiate the example machine-readable instructions and/or the example operations of FIGS. 5-8 to implement the touch device 102A of FIGS. 2 and 3. The programmable circuitry platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 900 of the illustrated example includes programmable circuitry 912. The programmable circuitry 912 of the illustrated example is hardware. For example, the programmable circuitry 912 can be implemented by one or more integrated circuits, logic circuits, FPGAs, microprocessors, CPUs, GPUs, DSPs, and/or microcontrollers from any desired family or manufacturer. The programmable circuitry 912 may be implemented by one or more semiconductor based (e.g., silicon based) devices. In this example, the programmable circuitry 912 implements the application 222A and the OS 212A.

The programmable circuitry 912 of the illustrated example includes a local memory 913 (e.g., a cache, registers, etc.). The programmable circuitry 912 of the illustrated example is in communication with main memory 914, 916, which includes a volatile memory 914 and a non-volatile memory 916, by a bus 918. The volatile memory 914 may be implemented by Synchronous Dynamic Random Access Memory (SDRAM), Dynamic Random Access Memory (DRAM), and/or any other type of RAM device. The non-volatile memory 916 may be implemented by flash memory and/or any other desired type of memory device. Access to the main memory 914, 916 of the illustrated example is controlled by a memory controller 917. In some examples, the memory controller 917 may be implemented by one or more integrated circuits, logic circuits, microcontrollers from any desired family or manufacturer, or any other type of circuitry to manage the flow of data going to and from the main memory 914, 916.

The programmable circuitry platform 900 of the illustrated example also includes interface circuitry 920. The interface circuitry 920 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface. In this example, the interface circuitry 920 implements the touch monitor circuitry 202A, the PHY circuitry 204A, the touch control circuitry 208A, and the NIC circuitry 210A.

In the illustrated example, one or more input devices 922 are connected to the interface circuitry 920. The input device(s) 922 permit(s) a user (e.g., a human user, a machine user, etc.) to enter data and/or commands into the programmable circuitry 912. The input device(s) 922 can be implemented by, for example, an audio sensor, a microphone, a camera (still or video), a keyboard, a button, a mouse, a touchscreen, a trackpad, a trackball, an isopoint device, and/or a voice recognition system. In this example, the input devices 922 include the One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 900 of the illustrated example also includes one or more mass storage discs or devices 928 to store firmware, software, and/or data. Examples of such mass storage discs or devices 928 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 932, which may be implemented by the machine-readable instructions of FIGS. 5-8, may be stored in the mass storage device 928, in the volatile memory 914, in the non-volatile memory 916, and/or on at least one non-transitory computer readable storage medium such as a CD or DVD which may be removable.

FIG. 10 is a block diagram of an example implementation of the programmable circuitry 912 of FIG. 9. In this example, the programmable circuitry 912 of FIG. 9 is implemented by a microprocessor 1000. For example, the microprocessor 1000 may be a general-purpose microprocessor (e.g., general-purpose microprocessor circuitry). The microprocessor 1000 executes some or all of the machine-readable instructions of the flowcharts of FIGS. 5-8 to effectively instantiate the circuitry of FIG. 2 as logic circuits to perform operations corresponding to those machine-readable instructions. In some such examples, the circuitry of FIGS. 2 and 3 is instantiated by the hardware circuits of the microprocessor 1000 in combination with the machine-readable instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine-readable instructions and/or operations represented by the flowcharts of FIGS. 5-8.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer-based operations. In other examples, the AL circuitry 1016 also performs floating-point operations. In yet other examples, the AL circuitry 1016 may include first AL circuitry that performs integer-based operations and second AL circuitry that performs floating-point operations. In some examples, the AL circuitry 1016 may be referred to as an Arithmetic Logic Unit (ALU).

The registers 1018 are semiconductor-based structures to store data and/or instructions such as results of one or more of the operations performed by the AL circuitry 1016 of the corresponding core 1002. For example, the registers 1018 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure, such as by being distributed throughout the core 1002 to shorten access time. The second bus 1022 may be implemented by at least one of an I2C bus, a SPI bus, a PCI bus, or a PCIe bus.

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMS s), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages.

The microprocessor 1000 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1000, in the same chip package as the microprocessor 1000 and/or in one or more separate packages from the microprocessor 1000.

FIG. 11 is a block diagram of another example implementation of the programmable circuitry 912 of FIG. 9. In this example, the programmable circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine-readable instructions. However, once configured, the FPGA circuitry 1100 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1000 of FIG. 10 described above (which is a general purpose device that may be programmed to execute some or all of the machine readable instructions represented by the flowchart(s) of FIGS. 5-8 but whose interconnections and logic circuitry are fixed once fabricated), the FPGA circuitry 1100 of the example of FIG. 11 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 5-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 5-8. As such, the FPGA circuitry 1100 may be configured and/or structured to effectively instantiate some or all of the operations/functions corresponding to the machine-readable instructions of the flowchart(s) of FIGS. 5-8 as dedicated logic circuits to perform the operations/functions corresponding to those software instructions in a dedicated manner analogous to an ASIC. Therefore, the FPGA circuitry 1100 may perform the operations/functions corresponding to the some or all of the machine-readable instructions of FIGS. 5-8 faster than the general-purpose microprocessor can execute the same.

In the example of FIG. 11, the FPGA circuitry 1100 is configured and/or structured in response to being programmed (and/or reprogrammed one or more times) based on a binary file. In some examples, the binary file may be compiled and/or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1100 of FIG. 11 may access and/or load the binary file to cause the FPGA circuitry 1100 of FIG. 11 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1100 of FIG. 11 to cause configuration and/or structuring of the FPGA circuitry 1100 of FIG. 11, or portion(s) thereof.

The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain a binary file, which may be implemented by a bit stream, data, and/or machine-readable instructions, to configure the FPGA circuitry 1100, or portion(s) thereof. In some such examples, the configuration circuitry 1104 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1106 may be implemented by external hardware circuitry. For example, the external hardware 1106 may be implemented by the microprocessor 1000 of FIG. 10.

The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations/functions that may correspond to at least some of the machine-readable instructions of FIGS. 5-8 and/or other desired operations. The logic gate circuitry 1108 shown in FIG. 11 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations/functions. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example dedicated operations circuitry 1114. In this example, the dedicated operations circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the programmable circuitry 912 of FIG. 9, many other approaches are contemplated. For example, FPGA circuitry may include an on-board CPU, such as one or more of the example CPU 1120 of FIG. 10. Therefore, the programmable circuitry 912 of FIG. 9 may additionally be implemented by combining at least the example microprocessor 1000 of FIG. 10 and the example FPGA circuitry 1100 of FIG. 11. In some such hybrid examples, one or more cores 1002 of FIG. 10 may execute a first portion of the machine readable instructions represented by the flowchart(s) of FIGS. 5-8 to perform first operation(s)/function(s), the FPGA circuitry 1100 of FIG. 11 may be configured and/or structured to perform second operation(s)/function(s) corresponding to a second portion of the machine readable instructions represented by the flowcharts of FIGS. 5-8, and/or an ASIC may be configured and/or structured to perform third operation(s)/function(s) corresponding to a third portion of the machine readable instructions represented by the flowcharts of FIGS. 5-8.

It should be understood that some or all of the circuitry of FIGS. 2 and 3 may, thus, be instantiated at the same or different times. For example, same and/or different portion(s) of the microprocessor 1000 of FIG. 10 may be programmed to execute portion(s) of machine-readable instructions at the same and/or different times. In some examples, same and/or different portion(s) of the FPGA circuitry 1100 of FIG. 11 may be configured and/or structured to perform operations/functions corresponding to portion(s) of machine-readable instructions at the same and/or different times.

In some examples, some or all of the circuitry of FIGS. 2 and 3 may be instantiated, for example, in one or more threads executing concurrently and/or in series. For example, the microprocessor 1000 of FIG. 10 may execute machine readable instructions in one or more threads executing concurrently and/or in series. In some examples, the FPGA circuitry 1100 of FIG. 11 may be configured and/or structured to carry out operations/functions concurrently and/or in series. Moreover, in some examples, some or all of the circuitry of FIGS. 2 and 3 may be implemented within one or more virtual machines and/or containers executing on the microprocessor 1000 of FIG. 10.

In some examples, the programmable circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the programmable circuitry 912 of FIG. 9, which may be in one or more packages. For example, the XPU may include a CPU (e.g., the microprocessor 1000 of FIG. 10, the CPU 1120 of FIG. 11, etc.) in one package, a DSP (e.g., the DSP 1122 of FIG. 11) in another package, a GPU in yet another package, and an FPGA (e.g., the FPGA circuitry 1100 of FIG. 11) in still yet another package.

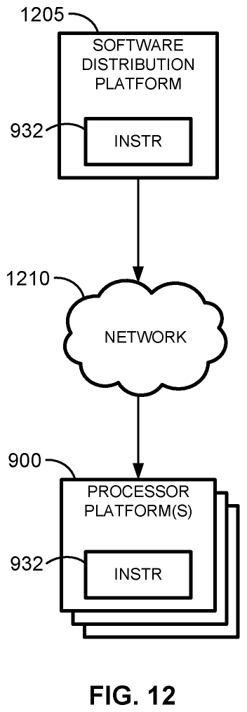

A block diagram illustrating an example software distribution platform 1205 to distribute software such as the example machine readable instructions 932 of FIG. 9 to other hardware devices (e.g., hardware devices owned and/or operated by third parties from the owner and/or operator of the software distribution platform) is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine-readable instructions 932, which may correspond to the example machine readable instructions of FIGS. 5-8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine-readable instructions 932 from the software distribution platform 1205. For example, the software, which may correspond to the example machine readable instructions of FIGS. 5-8, may be downloaded to the example programmable circuitry platform 900, which is to execute the machine-readable instructions 932 to implement the touch device 102A. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices. Although referred to as software above, the distributed “software” could alternatively be firmware.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

From the foregoing, it will be appreciated that example systems, apparatus, articles of manufacture, and methods have been disclosed that synchronize touch events between touch sensitive devices. Disclosed systems, apparatus, articles of manufacture, and methods improve the efficiency of using a computing device by employing local touch buffers, local NIC buffers, and TSN scheduling to transmit TLPs containing touch events packaged in VDMs over a communication fabric. The foregoing communication is implemented between touch control circuitry and NIC circuitry and does not involve exchange of data with system memory, an operating system, or a user space application. As a result, examples disclosed herein synchronize touch events between touch sensitive devices with less latency than other approaches, thereby improving performance and user experience. between Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to synchronize touch events are disclosed herein. Further examples and combinations thereof include the following.

Example 1 includes a network interface controller (NIC) comprising a buffer, and circuitry to configure a direct memory access (DMA) engine to access the buffer rather than a system memory when performing a DMA request, obtain event data from the buffer using a DMA request, the event data based on detection of a user input, and transmit a packet including the event data over a network.

Example 2 includes the NIC of example 1, wherein the circuitry is coupled to a communication fabric, and the circuitry is to obtain a message over the communication fabric from a user interface controller, the message including the event data, and store the event data in the buffer.

Example 3 includes the NIC of example 2, wherein the circuitry is to remove a TLP header from the message before transmitting the packet.

Example 4 includes the NIC of example 1, wherein the circuitry is to add a virtual local area network (VLAN) identification tag in the packet, the VLAN identification tag to identify the packet as containing event data.

Example 5 includes the NIC of example 1, wherein the circuitry is to generate the DMA request based on a transmission descriptor ring that identifies a memory address in the buffer of the NIC.

Example 6 includes the NIC of example 5, wherein the transmission descriptor ring is to initially identify a memory address in a system memory, and before generation of the DMA request, the circuitry is to modify the transmission descriptor ring to identify the memory address in the buffer of the NIC.

Example 7 includes the NIC of example 1, wherein the event data is local event data corresponding to a local event, the DMA request is a first DMA request, and the circuitry is to obtain external event data from a network, and generate a second DMA request to store the external event data in the buffer of the NIC.

Example 8 includes the NIC of example 7, wherein the circuitry is to generate the second DMA request based on a receiver buffer ring that identifies a memory address in the buffer of the NIC.

Example 9 includes the NIC of example 8, wherein the receiver buffer ring is to initially identify a memory address in a system memory, and before generation of the second DMA request, the circuitry is to modify the receiver buffer ring to identify the memory address in the buffer of the NIC.

Example 10 includes an apparatus to synchronize event data, the apparatus comprising interface circuitry coupled to a communication fabric, the communication fabric additionally coupled to a network interface controller (NIC), and offload engine circuitry to generate a message that includes event data based on detection of a user input, wherein the interface circuitry is to transmit the message to the NIC through the communication fabric.

Example 11 includes the apparatus of example 10, wherein the interface circuitry is to transmit the message to the NIC without intermediate storage of the message in a memory and without invoking an operating system.

Example 12 includes the apparatus of example 10, wherein the apparatus further includes a touch sensor, and the user input is detected by the touch sensor.

Example 13 includes the apparatus of example 10, wherein the interface control circuitry is to transmit the message as a vendor defined message (VDM) within a transaction layer packet (TLP).

Example 14 includes the apparatus of example 10, wherein the interface control circuitry is to transmit a write request to the NIC before transmitting the message.

Example 15 includes the apparatus of example 14, wherein the interface control circuitry is to transmit the message in response to receiving an approval message from the NIC.

Example 16 includes the apparatus of example 14, wherein the interface control circuitry is to receive a request to wait to transmit from the NIC.

Example 17 includes an apparatus to synchronize event data, the apparatus comprising first circuitry to implement a user interface controller, the user interface controller to detect a user input, transmit a message including event data to a network interface controller (NIC), the event data corresponding to the user input, and provide the event data to a driver to cause an event corresponding to the event data to be rendered by the apparatus, and second circuitry to implement the NIC, the NIC to store the event data from the message in a local buffer of the NIC, obtain the event data from the local buffer using a direct memory access (DMA) request, and transmit a packet including the event data over a network.

Example 18 includes the apparatus of example 17, wherein the first circuitry and the second circuitry are included in a system on a chip (SoC).

Example 19 includes the apparatus of example 17, wherein the apparatus includes a sideband fabric, and a primary fabric to implement data exchange at higher speeds than the sideband fabric, the user interface controller to transmit the event data to the NIC over the primary fabric.

Example 20 includes the apparatus of example 19, wherein the user interface controller and the NIC are to exchange local Precision Time Protocol (PTP) clock signals over the sideband fabric, and form a synchronous clock signal based on the local PTP clock signals, the synchronous clock signal used to transmit the event data to the NIC.

Example 21 includes a non-transitory machine-readable storage medium comprising instructions to cause programmable circuitry to at least configure a direct memory access (DMA) engine to access a local buffer rather than a system memory prior to a DMA request, obtain event data from the local buffer based on the DMA request, the event data based on detection of a user input, and transmit a packet including the event data over a network using an Application Program Interface (API) call.

Example 22 includes the non-transitory machine-readable storage medium of example 21, wherein the instructions cause the programmable circuitry to transmit the packet in response to receiving a query API call from an external device.

Example 23 includes the non-transitory machine-readable storage medium of example 21, the instructions cause the programmable circuitry to obtain a message over a communication fabric from a user interface controller, the message corresponding to an API call and including the event data, and store the event data in the local buffer.

Example 24 includes the non-transitory machine-readable storage medium of example 23, wherein the instructions cause the programmable circuitry to remove a transaction layer packet (TLP) header from the message before transmitting the packet.

Example 25 includes the non-transitory machine-readable storage medium of example 21, wherein the instructions cause the programmable circuitry to include a virtual local area network (VLAN) identification tag in the packet, the VLAN identification tag to identify the packet as containing event data.

Example 26 includes the non-transitory machine-readable storage medium of example 21, wherein the instructions cause the programmable circuitry to generate the DMA request based on a transmission descriptor ring that identifies a memory address in the local buffer.

Example 27 includes the non-transitory machine-readable storage medium of example 26, wherein the transmission descriptor ring is to initially identify a memory address in a system memory, and before generation of the DMA request, the instructions cause the programmable circuitry to modify the transmission descriptor ring to identify the memory address in the local buffer.

Example 28 includes the non-transitory machine-readable storage medium of example 21, wherein the event data corresponds to a touch event and the user input corresponds to a touch input.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A network interface controller (NIC) comprising:
a buffer; and
circuitry to:
configure a direct memory access (DMA) engine to access the buffer rather than a system memory prior to a DMA request;
obtain event data from the buffer based on the DMA request, the event data based on detection of a user input; and
transmit a packet including the event data over a network.

2. The NIC of claim 1, wherein:
the circuitry is coupled to a communication fabric; and
the circuitry is to:
obtain a message over the communication fabric from a user interface controller, the message including the event data; and
store the event data in the buffer.

3. The NIC of claim 2, wherein the circuitry is to remove a transaction layer packet (TLP) header from the message before transmitting the packet.

4. The NIC of claim 1, wherein the circuitry is to include a virtual local area network (VLAN) identification tag in the packet, the VLAN identification tag to identify the packet as containing event data.

5. The NIC of claim 1, wherein the circuitry is to generate the DMA request based on a transmission descriptor ring that identifies a memory address in the buffer of the NIC.

6. The NIC of claim 5, wherein the transmission descriptor ring is to initially identify a memory address in a system memory, and before generation of the DMA request, the circuitry is to modify the transmission descriptor ring to identify the memory address in the buffer of the NIC.

7. The NIC of claim 1, wherein the event data is local event data corresponding to a local event, the DMA request is a first DMA request, and the circuitry is to:
obtain external event data from a network; and
generate a second DMA request to store the external event data in the buffer of the NIC.

8. The NIC of claim 7, wherein the circuitry is to generate the second DMA request based on a receiver buffer ring that identifies a memory address in the buffer of the NIC.

9. The NIC of claim 8, wherein the receiver buffer ring is to initially identify a memory address in a system memory, and before generation of the second DMA request, the circuitry is to modify the receiver buffer ring to identify the memory address in the buffer of the NIC.

10. The NIC of claim 1, wherein the event data corresponds to a touch event and the user input corresponds to a touch input.

11-17. (canceled)

18. An apparatus to synchronize event data, the apparatus comprising:
first circuitry to implement a user interface controller, the user interface controller to:
detect a user input;
transmit a message including event data to a network interface controller (NIC), the event data corresponding to the user input; and
provide the event data to a driver to cause an event corresponding to the event data to be rendered by the apparatus; and
second circuitry to implement the NIC, the NIC to:
store the event data from the message in a local buffer of the NIC;
obtain the event data from the local buffer using a direct memory access (DMA) request; and
transmit a packet including the event data over a network.

19. The apparatus of claim 18, wherein the apparatus includes:
a sideband fabric; and
a primary fabric to implement data exchange at higher speeds than the sideband fabric, the user interface controller to transmit the event data to the NIC over the primary fabric.

20. The apparatus of claim 19, wherein the user interface controller and the NIC are to:
exchange local Precision Time Protocol (PTP) clock signals over the sideband fabric; and
form a synchronous clock signal based on the local PTP clock signals, the synchronous clock signal used to transmit the event data to the NIC.

21. A non-transitory machine-readable storage medium comprising instructions to cause programmable circuitry to at least:
configure a direct memory access (DMA) engine to access a local buffer rather than a system memory prior to a DMA request;
obtain event data from the local buffer based on the DMA request, the event data based on detection of a user input; and
transmit a packet including the event data over a network using an Application Program Interface (API) call.

22. The non-transitory machine-readable storage medium of claim 21, wherein the instructions are to cause the programmable circuitry is to transmit the packet in response to receiving a query API call from an external device.

23. The non-transitory machine-readable storage medium of claim 21, wherein the instructions are to cause the programmable circuitry to:
obtain a message over a communication fabric from a user interface controller, the message corresponding to an API call and including the event data; and
store the event data in the local buffer.

24. The non-transitory machine-readable storage medium of claim 23, wherein the instructions are to cause the programmable circuitry to remove a transaction layer packet (TLP) header from the message before transmitting the packet.

25. The non-transitory machine-readable storage medium of claim 21, wherein the instructions are to cause the programmable circuitry to include a virtual local area network (VLAN) identification tag in the packet, the VLAN identification tag to identify the packet as containing event data.

26. The non-transitory machine-readable storage medium of claim 21, wherein the instructions are to cause the programmable circuitry to generate the DMA request based on a transmission descriptor ring that identifies a memory address in the local buffer.

27. The non-transitory machine-readable storage medium of claim 26, wherein the transmission descriptor ring is to initially identify a memory address in a system memory, and before generation of the DMA request, the instructions are to cause the programmable circuitry to modify the transmission descriptor ring to identify the memory address in the local buffer.

28. (canceled)
